(19) United States
(12) Patent Application Publication
(10) Pub. No.: US 2002/0128879 A1
(43) Pub. Date: Sep. 12, 2002

(54) System and method for providing online management of medical savings accounts and benefits selection

(76) Inventor: Myron Spears, Elizabethtown, KY (US)

Correspondence Address: Kevin T. Duncan, Esq., Hunton & Williams, Suite 1200, 1900 K Street, Washington, DC, 20006-1109, US

(21) Appl. No.: 09/933,141

(22) Filed: Aug. 21, 2001

Related U.S. Application Data
(60) Provisional application No. 60/226,591, filed on Aug. 21, 2000.

(51) Int. Cl. G06F 17/60

(52) U.S. Cl. 705/4; 705/1

(57) ABSTRACT

The present invention offers a system to deliver and manage personalized health care information, health care financial services, and an insurance and provider marketplace, and provides an enhanced and enticing consumer experience not achieved in the declining managed care model. The system provides a health portal that navigates the consumer and other stakeholders to a personalized homepage that links them to the insurance marketplace, the products and services marketplace, and to their own personalized information center and medical financial account(s). From this site, employers can customize their benefits plan offerings, consumers can customize their benefits package, enroll, search for and receive “pushed” health information based on their profile, manage medical finances, and find discounts on medical products and services when needed. The system provides on-demand health care and other benefits information, efficient marketplaces, financial services, and enhanced customer service to customers—consumers, providers, employers and insurers, by using information technology to provide accurate, instantaneous customer transactions and uses innovation to enhance the value of information-driven services to all stakeholders.

### CROSS-REFERENCE TO RELATED APPLICATIONS

This application claims the benefit of U.S. Provisional Application No. 60/226,591, entitled System and Method For Providing Online Management Of Medical Savings Accounts And Benefits Selection, filed on Aug. 21, 2000, which is incorporated herein by reference in its entirety.

### FIELD OF THE INVENTION

The invention relates generally to transaction-based systems directed to connecting consumers with service and product providers for consummating goods and services selection and facilitating individual and service provider management of accounts. More particularly, the system of the present invention empowers consumers to manage qualified and unqualified savings accounts and employers to manage benefits offerings to employees.

### BACKGROUND

An increasing societal concern is skyrocketing costs of benefits, including medical, dental and life insurance, that are widely viewed as out-of-control. Employers, employees and other consumers want simplicity in health insurance and greater control and open access to choice of providers. The model of the Health Maintenance Organization (“HMO”) not only takes access and control away from the consumer, it also removes the consumer from the chain of commerce. That is, the consumer who receives the benefit of the service does not, at least in large part, actually pay for nor negotiate for the cost of the service. Accordingly, the consumer is dispossessed of incentives to keep costs down, monitor billing for inappropriate charges, etc. The demand for open access is apparent in rising membership in products that don't restrict access and in decline of restrictive plan membership. While network HMOs have grown 16% annually the past decade, less restrictive PPO and POS plans have grown 35%.

The health industry is moving toward a customer-centric model and more and more consumers have access to and demand online services. Rapidly rising consumer knowledge about health care and demand for more choice and more individual attention make this move necessary for the industry. Health care consumers are becoming situationally aware and instant experts on health topics that concern them. Their access to information is increasing dramatically, not only through the Internet but also through accreditation agencies and popular press. Further fueling the drive to a customer-centric model, baby boomers, who often must coordinate care for their parents, their children, and themselves, have made health care a primary issue.

On the provider side, both the administrative load and complexity of the physician's office continue to grow and have become an increasing drain on time and component to the cost of service. Growth of managed care has added numerous plans and benefit variations to the staff's workload. Physician's offices contract with an average of 18 health insurers, up from 11 in 1995. Further, almost 60% of physician's offices interface with more than ten health insurers.

The addition of health plans has also grown the number of formularies (approved drug lists) physicians are working with. Forty-two percent of physicians work with seven or more formularies; the average is ten.

Physicians are pushing back against managed care. Physician criticism of plans can be particularly devastating, as they are the primary source of contact with members. A recent poll of 10,000 physicians revealed:

61% of physicians were mostly negative when talking to patients about managed care, 30% were neutral, 5% were positive, and 4% never discussed managed care with their patients.

26% of physicians were considering terminating managed care contracts.

Physicians want to bond with their patients and ignore managed care—9% were considering offering cash discounts to avoid managed care paperwork.

Employers—Worried About Medical Costs and Lawsuits, Demanding Customer Service

Ever rising medical costs have caused employers to become increasingly concerned about how to provide benefits to their employees, especially small group employers. In many instances employers have discontinued certain benefits due to the rising costs and the lack of control. A recent poll shows employers who thought medical costs were under control decreased to 67% in 1999 from 78% in 1995. Over the same period, the portion of employers who thought costs were out of control increased to 31% from 21%. The number of employers expecting costs to rise increased to 69% from 57%.

A growing concern for employers is litigation against managed care organizations. Employers dictate and design the health coverage provided for their employees and run the risk of being named as defendants in civil suits.

Employers are also demanding better customer service. While small group employers are more concerned with cost, larger groups want their employees satisfied with their benefits package. Benefits are a key incentive for retaining talent in a highly competitive job market.

Summary of the Current Environment

Many stakeholders—consumers, providers, and employers—are dissatisfied with the current health insurance environment. For one stakeholder to gain, others must lose. However, opportunity lies in the common denominator for all players—the need for accurate health care information, communication, efficiency, simplicity, and incentives for managing and maintaining health.

As an industry model, managed health care is at a strategic inflection point. Today's managed care business model, which arose as a logical response to then-current market conditions, is clearly under fire from every angle. Physicians, consumers, legislators, lawyers, the news media, the courts—all are dissatisfied with the product delivered by managed care. Further, as the industry has matured, it has followed an efficiency path that has reduced margins to levels at which investment is difficult and any unforeseen, unfavorable variable can cause dramatically unfavorable financial outcomes. The sharp focus of the current model, cost and utilization control, accomplished its goal for a time but is under increasingly hostile fire in today's markets.

By reviewing the relationship of consumers, physicians, and insurers in the past and present, and projecting these evolving relationships into the future (with the impact of environmental factors), it is reasonable to forecast the emergence of a significantly different model.

Contrast the environment prior to 1980 with that of today. Prior to 1980, individual consumers, who generally lacked access to health care information and, thus, had limited health care knowledge, took little responsibility for their own health care delivery decisions. In the absence of other coordinators of care, physicians took full responsibility for health care decisions. The environment was “The doctor knows best.” Patients were covered by indemnity plans that paid for a percentage of whatever was ordered.

Responding to market opportunity, managed care companies emerged in the 1980's as a means to control skyrocketing medical costs—first by setting up networks with gatekeepers physicians, then through capitation, then through leveraging large membership bases to control provider actions. But medical costs continued to increase because none of the parties-in-interest at the point of service is incentivized or armed with adequate information to reduce costs.

Consumers and providers now navigate a complex medical system of referrals, authorizations, and pre-certifications and are often inundated with paperwork to get the care they need. Managed care companies have positioned themselves—both through intentional actions and through passively accepting a role foisted upon them—as the final arbiter of health care decisions and taken the central role in each individual's health care plan. But consumers, with access to more health information via the Internet and other media, are demanding and taking control of their health decisions, and physicians are striking back to regain their former status at the center of health care decisions. More confident consumers and physicians want insurers out of decision making on medical care.

A relatively new concept to enter the picture is the Medical Savings Account (MSA). There is currently a 750,000 cap on the number of tax-deferred MSAs that are allowed under the 1996 HIPPA provision. These MSAs are limited to self-employed individuals and employees in small groups (1-50). The expansion of MSA enrollment guidelines continue to be a focus of debate in Congress. Many expect Congress to pass a patient's bill of rights in the very near future. While many in Congress have expressed their desire for MSA expansion to be included in such legislation, the debate continues.

Technology and its Impact on Business Models

The Internet's impact on “Old Economy” business models is revolutionary. Four key aspects of the health care environment change fundamentally as a result:

Speed—Digital business isn't just faster; it's effectively instant, which means old structures and capabilities may actually be a handicap.

Knowledge—Digital business creates a new level of personalized information and management tools that empower consumers.

Control—The Internet transfers power from organizations to individuals, particularly consumers.

Business Models—These three transformations (speed, knowledge, and control) make entirely new business models viable.

The Internet wave has already engulfed and re-shaped the financial services and retail industries with new players, new economics (e-brokers), and new models (auctions). What is needed is for the health care industry to use the Internet and related technology to empower employers and consumers to have greater control over their plans and service selection and to control costs of services.

Consumer Internet Use for Health Care Information

There are currently 88 million adults in the United States using the Internet. A recent poll showed 60 million adults have searched the web for health care information in the past 12 months. That's 68% of the adult web users. A 1999 Internet usage survey shows:

Nationwide, 80% of people on the Internet access it from home and 50% access it from work. There are no regional differences but there were differences within Market Statistical Areas (See discussion of potential markets in page 14)

As corporations roll out Internet access, the at-work audience is growing more than 50% a year (currently at 20 million in the United States).

The worldwide at-work Internet audience will exceed 200 million by 2004.

The IRS has reported that growth of MSAs has been slow (only 42,477 taxpayers contributed to an MSA in 1998). Insurance companies have been slow to develop similar products as they are not equipped with systems to manage the transactions. A number of companies that have emerged as content players, e.g., Dr. Koop, WebMD, OnHealth, HealthCentral, and several companies, e.g., HealthAxis, healthinsurance.com, have emerged to sell health insurance on-line with little more than cost comparisons. Although some managed care companies appear to be going digital, they are doing little more than web-enabling the managed care model that no is longer effective rather than inventing a new operating model.

What is needed is a system that will provide health information and health insurance information, among other things, to consumers, both individuals and businesses. Consumers are turning to the Internet for choice, convenience (service), mobility, and real time information—none of which is currently offered by any health insurer.

Future. The dominant care management model of the next generation will be that of benefits information consolidator and integrator of services that empower the consumer to make choices best for them in consultation with their doctors and other service providers. Although managed care companies are striving to “e” enable and digitize the current model for administrative savings and access to real-time information (allowing them to more effectively intrude in treatment settings), stakeholders are impatiently waiting for a new model that provides greater access and options and that leverages the information, customization, personalization, convenience, self-service and simplicity features that the Internet provides.

What is needed is a system to bring together the components of a consumer-centric health insurance model to simplify the experience and delight the stakeholders—consumer, provider, and employer. The following is needed to bring this about:

An environment for consumers to customize benefit packages that meet their needs.;

A market for benefit commodities (insurance, health products, medical, and financial services);

Personalized health care information and medical financial management tools; and

Financial services and world-class customer service.

### SUMMARY OF THE INVENTION

The system of the present invention, and the methods associated therewith, is referred to herein and in the figures as “HealthBucks.” The present invention offers personalized health care information, health care financial services, an insurance and provider marketplace, and an enhanced and enticing consumer experience not achieved in the declining managed care model.

HealthBucks solves the problems in today's health care system: complexity, unavailable or old information for business decisions, mountains of administrative paperwork and billions of dollars wasted on administration, mistakes caused by repetitive manual processes, and non-value added processes linked to generation-old technologies. HealthBucks will also overcome the chief compromises today's insurers force on their customers: slow claims payment, wasting time to understand and administer their benefits and contracts, repeat customer service interactions to accomplish incomplete tasks, inability to access information about their own health care or contracts, lack of accurate cost data, uncertainty about complex benefit coverage, slow customer service response, complex paper trails, and no provision for unlimited access and self-service.

At the center of HealthBucks (FIGS. 1 and 2) is a health portal that navigates the consumer and other stakeholders to their personalized homepage (MyHealthBucks) that links them to the insurance marketplace, the products and services marketplace, and to their own personalized information center and medical financial account(s). From this site, employers can customize their benefits plan offerings, consumers can customize their benefits package, enroll, search for and receive “pushed” health information based on their profile, manage medical finances, and find discounts on medical products and services when needed.

HealthBucks creates on-demand health care and other benefits information, efficient marketplaces, financial services, and enhanced customer service to customers—consumers, providers, employers and insurers. The present invention uses information technology to provide accurate, instantaneous customer transactions and uses innovation to enhance the value of information-driven services to all stakeholders.

The Information Technology

In one embodiment, the HealthBucks system includes server computers connected to remote users, consumers, service providers, employers, participating insurance companies, etc. via the Internet or any other distributional network infrastructure. All customer transactions arrive electronically, are processed essentially without human intervention, and are dispatched electronically. Insurers, providers, and commerce partners update their offerings and prices in real-time to compete for business. Consumers customize benefits, enroll, purchase, search for information, and pay electronically. In one embodiment, the system employs state-of-the-art Internet and database technologies supporting a base of operation such as shown in FIG. 3.

HealthBucks' custom-developed core contains digital assets including: state-of-the-art master information stores; common services shared by applications; and a communication infrastructure to communicate with all stakeholders. The core enables real-time transaction processing for customers and accurate performance information for internal usage—thus optimizing management of the profitability and strategic direction. Around the core are the applications that plug into its resources. HealthBucks concentrates custom development work on externally facing customer applications to most effectively differentiate products, services, and value propositions. On the shelf products (for example, Oracle's exchange system software package and a health care information provider such as WebMD) may be employed in the overall system.

HealthBucks' core architecture is comprised of systems that organize data around the stakeholder, increasing their situational awareness—whether consumer, insurer, provider, or employer. This structure enables customers to create benefits packages that meet their needs and provides both real-time and self-service responses to customer inquiries and real-time mass customization of products and offerings. These features translate directly into better service, lower cost, and greater value for customers through, among other things, immediate, accurate answers to customer questions on coverage, patient treatment transactions, and costs.

HealthBucks provides the capability for consumers to design their own benefits packages based on their own needs, whether self-employed or based on employer contributions. The initial product is based on the provisions of the 1996 Health Insurance Portability and Accountability Act (HIPPA) that encourages self-employed and employees of small groups (1-50) to “build reserves for future medical expenses.” The current law allows for individuals to create Medical Savings Account (MSAs) when attached to high-deductible health insurance (FIG. 4).

Tax-deferred contributions are limited to 75% of the deductible for families (65% for individuals) with limits on deductibles of $3,050 to $4,600 for families and $1,550 to $2,300 for individuals. Interestingly, the maximum out of pocket expenses with this product design for consumers is 25% of the deductible which compares to that of many PPO type products with deductibles, co-insurances, and co-payments. Preliminary analysis of the HealthBucks' product has shown a 25% cost savings over tradition managed care products (HMO/PPO) with similar benefits. HealthBucks provides total freedom to the consumer, and simplicity in execution for both consumers and providers. HealthBucks bundles other benefits such as dental, life, and disability insurance.

Lower cost, simplicity, better customer service, better health care products, and real-time accuracy are value propositions of the HealthBucks system. Consumers, providers, and employers all gain from HealthBucks' business model. Even insurers gain from the model because they can focus on their core competency of managing risk for catastrophic events and not intervene on the portion of medical expense that is not within their means to control (pharma, outpatient services) without adding controls that confuse, complicate, and dissatisfy customers. These decisions are best left to patients and their providers who must weigh treatment options on both outcome and cost.

HealthBucks will continue to pursue extensions of its model to all facets of the health care industry. The financial transaction backbone that the company will develop—leveraging the banking system—will allow it to provide administrative and payment services for any of the federal programs such as Medicare, Veterans Administration, or TRICARE (military) and state programs such as Medicaid.

The HealthBucks business model provides a diverse and extensive e-commerce facility capable of generating revenue from multiple sources. In addition to management fees and sales commissions described earlier, HealthBucks derives revenue from all comers of its model. It is possible that HealthBucks can derive revenue from customers who are not insurance members but who seek information, commerce opportunities, or desire the HealthBucks credit card. Although there are multiple revenue streams, the preliminary financial model is driven by management fees and insurance commissions. The important note is that revenue is gained from HealthBucks accounts no matter where it is transacted. If it stays in the account, HealthBucks gains an interest share. If it is drawn from the account, HealthBucks shares in the transaction fee with the banker, in addition to click through revenue or bounties gained from on-line (for example, PlanetRx) or off-line (for example, fitness centers) commerce partners. FIGS. 5 and 10 outline the revenue model.

HealthBucks goes beyond the discrete content, connectivity, and commerce plays of first-generation Internet business models. It utilizes the efficiencies and the connectivity of the Internet, or any other distributed network for that matter, and revolutionizes the present health insurance operating model to put the power in the hands of consumers and doctors.

HealthBucks marries the best attributes of PPO type plans with the advantages associated with high deductible insurance and presents consumers with customizable plan making facilities to create the most advantageous benefits package to that person or group. HealthBucks provides personalized health care information, customized benefits packages, creation of efficient markets, financial tools and services, and enhanced customer service.

The IRS has reported that growth of MSAs has been slow (only 42,477 taxpayers contributed to an MSA in 1998). Insurance companies have been slow to develop similar products as they are not equipped with systems to manage the transactions. While there are a number of companies that have emerged as content players (Dr. Koop, WebMD, OnHealth, HealthCentral), their models have been primarily limited to advertising and sponsorships. Several competitors (HealthAxis, healthinsurance.com) have emerged to sell health insurance on-line but to date are believed to only provide cost comparisons. Managed care companies are going digital and are doing little more than “e” enabling the managed care model that nobody wants. To date, efforts to build electronic commerce capabilities have focused on piecemeal development of automated components of existing processes, not on reinventing the operating model itself.

### BRIEF DESCRIPTION OF THE DRAWINGS

FIG. 1 is a schematic diagram illustrating one embodiment of the distributed network architecture of the HealthBucks system;

FIG. 2 is a block diagram illustrating the interaction between and among stack holders and participants in the HealthBucks system of FIG. 1.;

FIG. 3 is a schematic diagram illustrating internal and external directed applications associated with the system of FIG. 1;

FIG. 4 is a block diagram illustrating the health benefits MSA model associated with the system of FIG. 1;

FIG. 5 is a schematic diagram illustrating anticipated revenue streams associated with the business model of the system of FIG. 1;

FIG. 6 illustrates one aspect of the financial services component of the model of FIG. 5;

FIG. 7 illustrates the financial services and insurance market place components of the business model of FIG. 5;

FIG. 8 illustrates the interaction associated with the financial services and products and services market place components of the business model of FIG. 5;

FIG. 8 illustrates further interaction among components of the business model of FIG. 5;

FIG. 10 illustrates the combined interaction of the components illustrated in FIGS. 6-9;

FIG. 11 is a schematic diagram illustrating an example of data input, flow and processing associated with a user customizing a benefits plan using the system of FIG. 1;

FIG. 12 is a schematic diagram illustrating the bundling of benefits to build a personal benefits package using the system of FIG. 1;

FIG. 13 is a screen shot of a benefit plan design Web page of a graphical user interface associated with the system of FIG. 1;

FIG. 14 illustrates a screen shot of a benefit plan summary Web page of a graphical user interface associated with the system of FIG. 1;

FIGS. 15 and 16 are screen shots of a health panel Web page of a graphical user interface associated with the system of FIG. 1;

FIG. 17 is a screen shot of a second benefit plan summary Web page of a graphical user interface associated with system of FIG. 1;

FIG. 18 is a screen shot of a second benefit plan design Web page of a graphical user interface associated with the system of FIG. 1;

FIG. 19 is a screen shot of a third benefit plan summary Web page of a graphical user interface associated with the system of FIG. 1;

FIG. 20 is a screen shot of a second health panel Web page of a graphical user interface associated with the system of FIG. 1;

FIG. 21 is a screen shot of fourth benefit plan summary Web page of a graphical user interface associated with the system of FIG. 1;

FIG. 22 is a screen shot of a third benefit plan designed Web page of a graphical user interface associated with the system of FIG. 1;

FIG. 23 is a screen shot of a fourth benefit plan summary Web page that may be of the graphical user interface associated with the system of FIG. 1;

FIG. 24 is a screen shot of a Welcome Web page of a graphical user interface associated with the system of FIG. 1;

FIG. 25 is a block diagram illustrating the payment transaction process associated with the business model of the system of FIG. 1;

FIG. 26 is a block diagram illustrating premium and fee flow associated with the management of accounts and services in the business model associated with the system of FIG. 1;

FIG. 27 illustrates objects of the system of FIG. 1;

FIG. 28 illustrates a first comparison of the system of FIG. 1 with a traditional managed care model;

FIG. 29 illustrates a second comparison of the system of FIG. 1 with a traditional managed care model; and

FIG. 30 is a comparison table summarizing the examples of FIGS. 28 and 29.

### DETAILED DESCRIPTION OF THE INVENTION

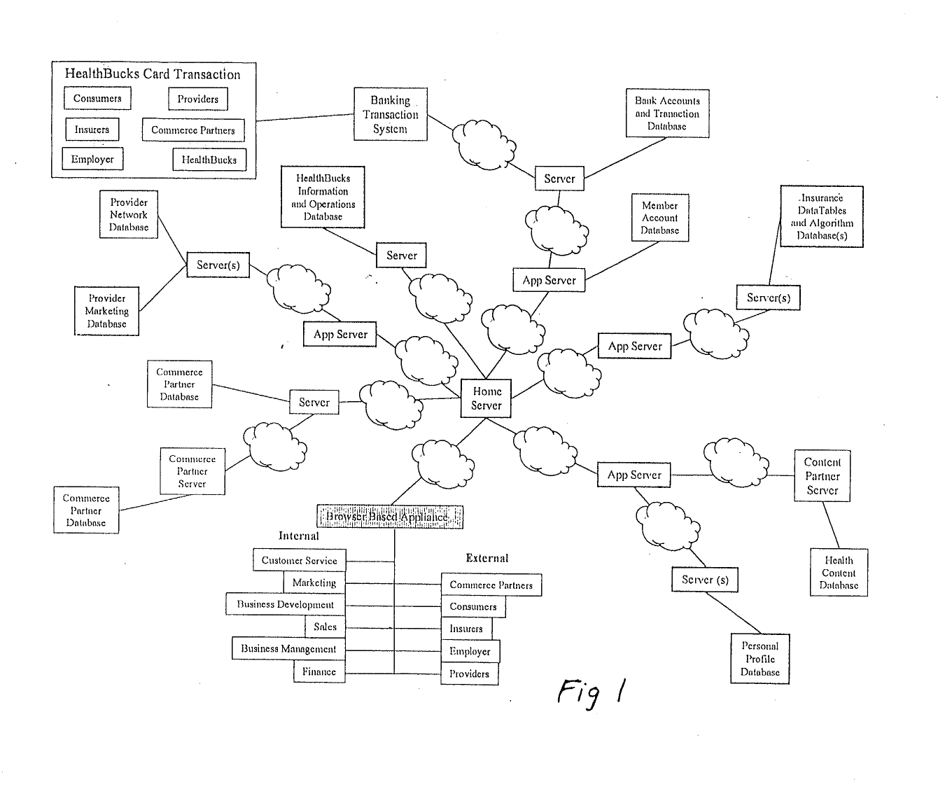

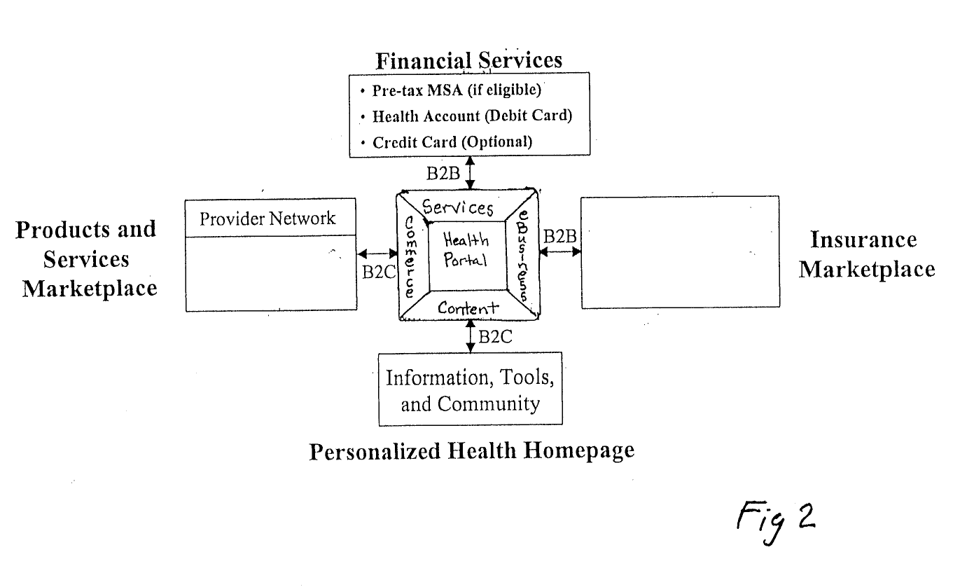

With reference to FIGS. 1 and 2, HealthBucks includes a portal which represents the users' initial point of entry. The home server enables the users to navigate through the system. Tables 1 and 2 illustrate the external and the internal stakeholders and some of the functionality and objects in this system. Users access the home server through a browser such as via a computer, a cell phone, a PDA, web appliance, etc.

For instance, a business development person striking a deal with either a commerce partner or with a provider may, in real time, access the Internet in a mobile fashion to get them up on the platform. The user accesses the home server, the portal, through a browser, and that can be on any type of appliance. From the home server, depending upon the type of user, for instance, consumer's that work for an employer, or perhaps self employed persons, the user can design a benefits package. An employer defines a contribution of what they will provide its employees and the individual employee takes that defined contribution and designs their own benefits package, including their health, life, disability, dental, etc. The package is designed in real time by use of an application server capable of accessing data tables and algorithms, and in essentially real time it will calculate the premiums and add all those and break them out in terms of what the employer will pay and what the employee will pay. For instance, the benefits package is based on a high deductible health insurance product along with a medical savings account (MSA).

Insurance data tables and algorithms databases and employer specific information are stored at over or more databases—either at the Home Services or at other sources. In one manner, the application server pulls ore receives information specific to the employer from a remote user site.

Referring to FIG. 1, the Health Bucks Information and Operations Database handles, among other things, registering employers and building employer benefits packages. For instance, an account representative or an employer directly inputs the employer's data including address, number of employees, plan preferences, other administrative data, what the defined contribution is to be, etc. The application server is used to design the benefits plan and will draw from that database to get the defined contribution.

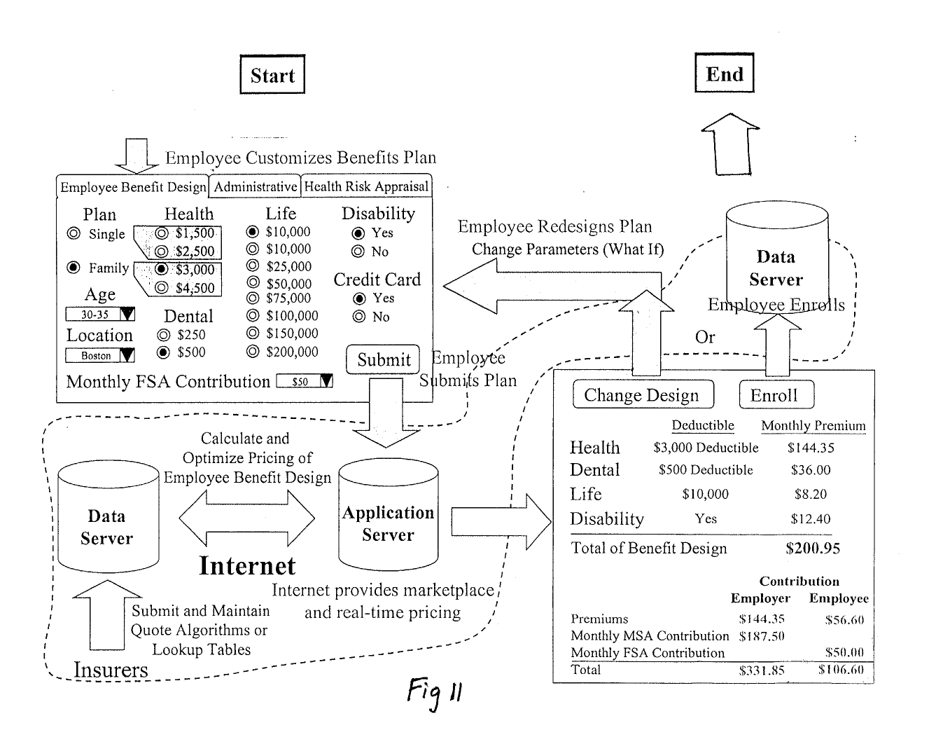

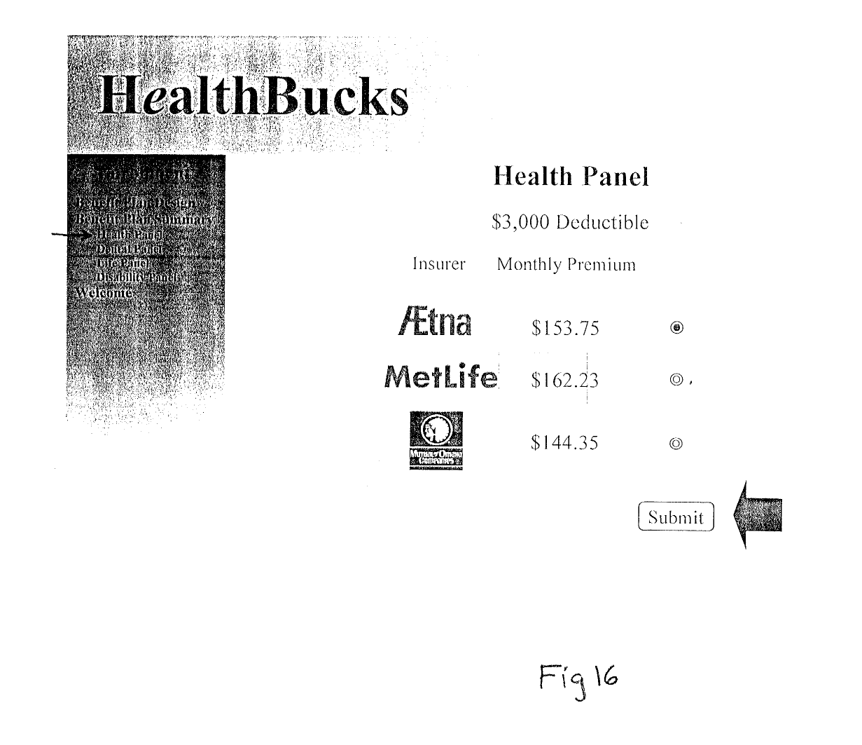

Referring now to FIGS. 11-24, once an employee is logged on or otherwise accesses the employer's health plan, the system presents the employee with a screen for completing profile information, e.g., I have a family, I am this age, this is where I am located, etc. Those are the sort of drivers that determine what the actual premiums for that specific employee are. The employee makes benefit selections and a personalized plan based upon deductibles and other information they want, whether they want life insurance, disability, a credit card, etc. Also, if employees want to contribute out of their own pockets pre-tax money into a flexible savings account (FSA), they could put that on there as well. For instance, the system may employ a query to an application server and then to the servers where the data is stored.

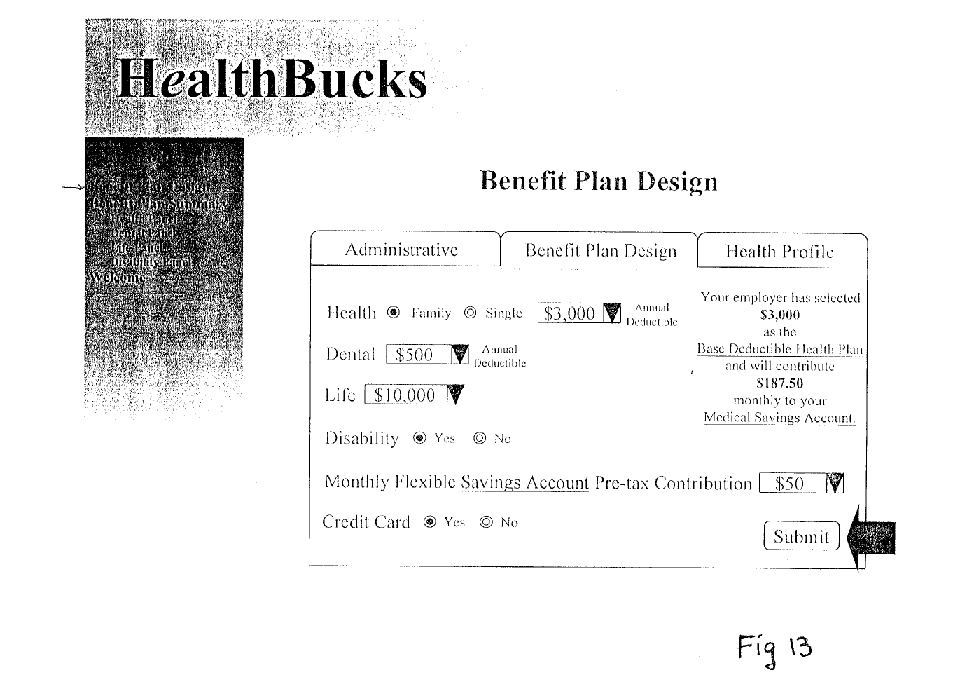

The following description relates to FIGS. 13 through 24 and illustrates the process of dispensing a benefits plan in an online fashion. As illustrated by the screen shot of FIG. 13, the employee has previously filled out the administrative data (common denominator of all of the insurer's administrative requirements. Items such as age, location, single or family, etc. serve as inputs to query the insurers' data tables for premium calculation.

In this case, the employer has established a $3,000 annual deductible as the base plan with a $187.50 monthly contribution to a medical savings account (or 75% of the annual deductible). This is the plan that the employee can deviate from in his/her benefit customization.

The employee has decided to stick with the $3,000 deductible plan, take a $500 deductible dental plan, $10,000 of term life, and desires disability insurance in case of illness. The employee also desires to contribute $50 per month to the pre-tax FSA, and desires his/her HealthBucks to also serve as a credit card.

After designing the plan, the employee submits the plan for cost.

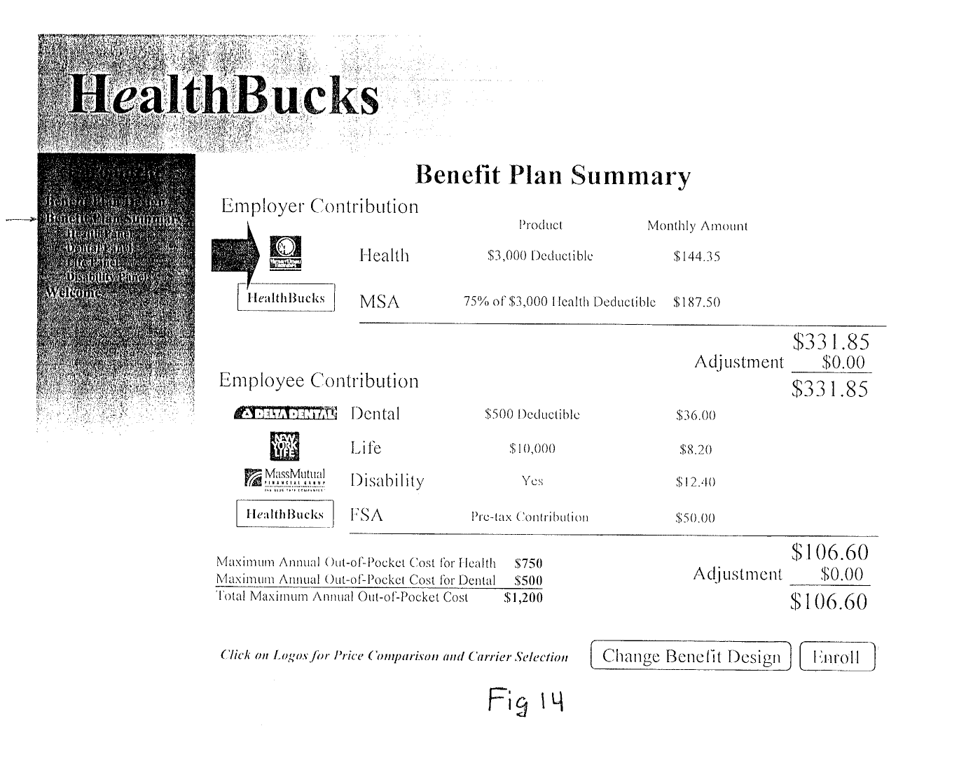

As illustrated by the screen shot of FIG. 14, HealthBucks provides a summary of the plan design and breaks out employer and employee contributions based on the base plan that the employer selected and selections made by the employee.

The summary contains the monthly premiums of each benefit and provides a running total of maximum annual out-of-pocket expenses that the employee could expect to pay.

HealthBucks will always return the lowest cost during the initial submission but will remember all changes going forward.

In this case, the employee wants to conduct some due diligence on his/her health plan. By clicking on the Mutual of Omaha logo, he/she can drill down into the health panel to see which insurers made the cut and what their premiums are.

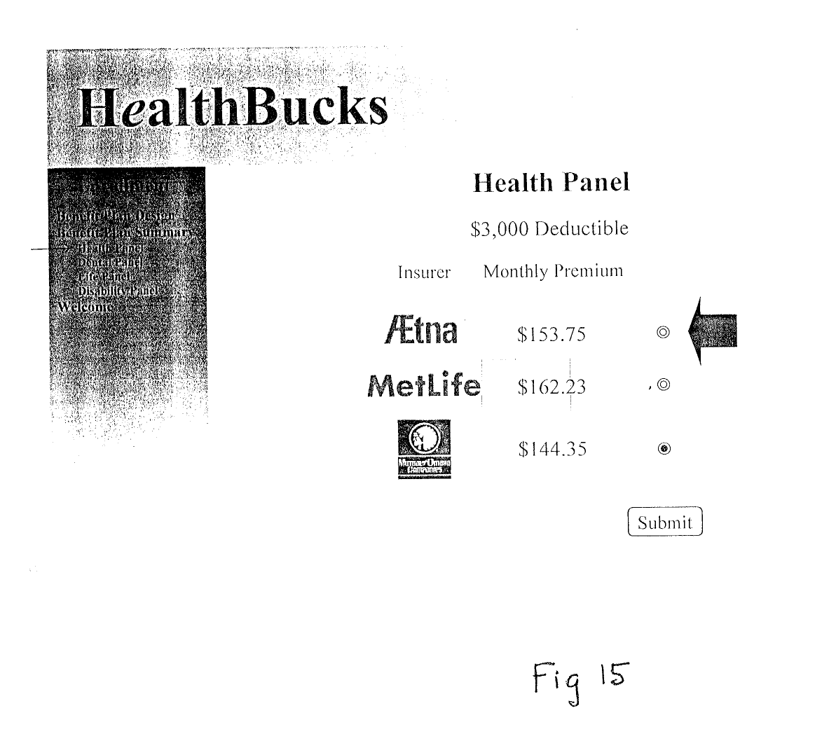

As illustrated at FIG. 15, the employee can see the price trade-off for each insurer.

In this example, the employee prefers Aetna, and is willing to pay the difference to select it.

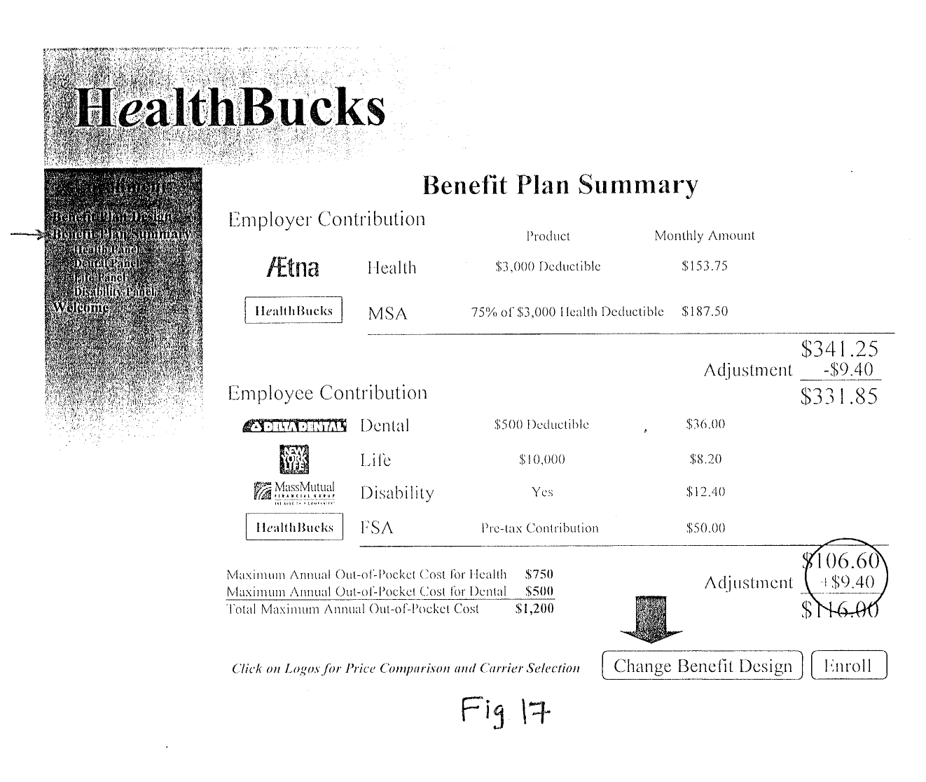

As illustrated at FIG. 17, the employee selects Aetna, and submits the change.

The change is submitted and a new summary is created.

Note that Aetna's health insurance comes with a $9.40 additional charge that is passed onto the employee as an adjustment to the benefit plan.

The employee wants to see what the impact of the deductible is on his/her overall benefit plan and desires to change the benefit design.

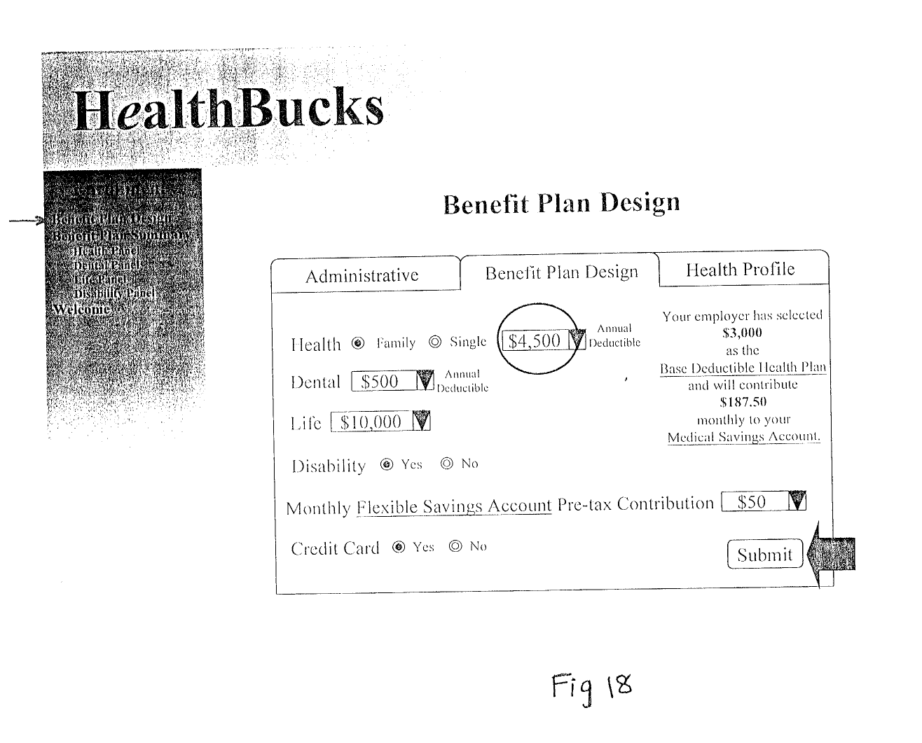

With reference to FIG. 18, the employee is returned to the Benefit Plan Design page where he/she can change the deductible on the health plan and submit the plan for costing.

In this case, the employee selects a $4,500 annual deductible.

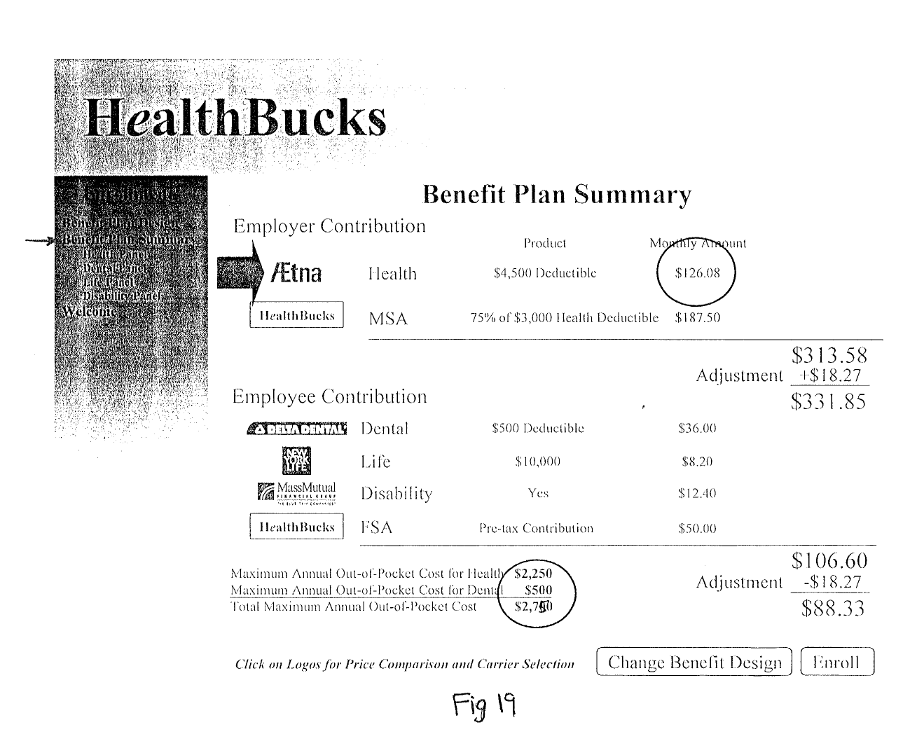

With reference to FIG. 19, the plan recalculates the plans cost remembering that the employee preferred Aetna as the health insurance carrier.

The employee notes the maximum out-of-pocket cost has increased to $2,750 while saving him/her only $18.27 a month. Note the employer does not contribute more to the MSA (75% of deductible) and the employee cannot contribute the difference because the law does not allow both employer and employee to contribute to the MSA (must be one or the other). However, HealthBucks database structure and system are flexible in design to permit this and other features should the law change.

The employee wants to know if he/she can save more per month on the health premium by changing carriers. He/she decides to drill down in to the health panel again for more detail.

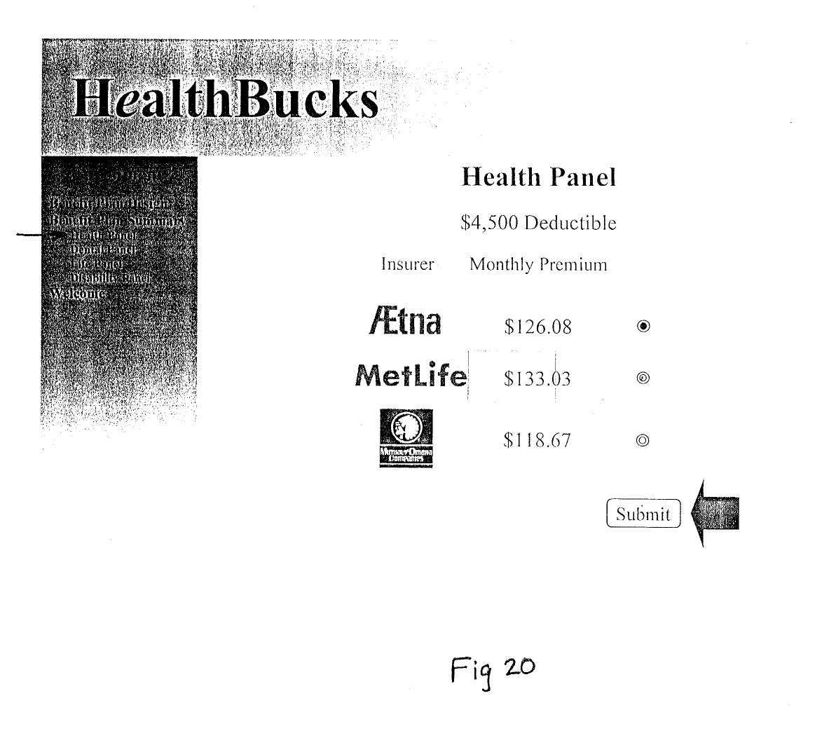

With reference to FIG. 20, Drilling down to the health panel reveals there is not much to be gained by changing carriers.

The employee still desires to stay with Aetna and leaves the health panel.

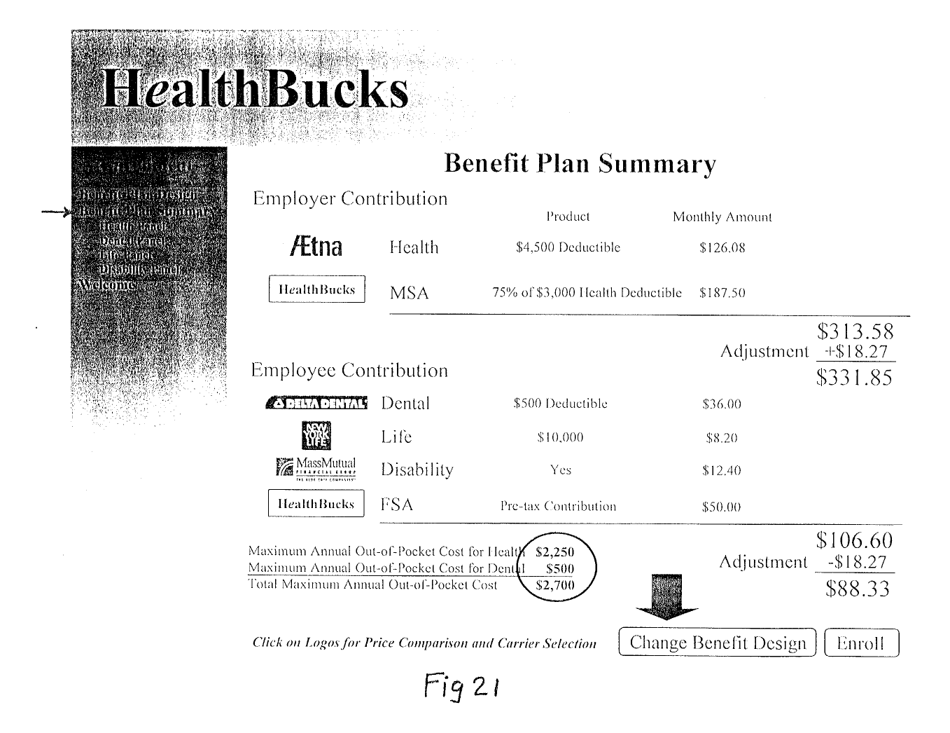

With reference to FIG. 21, the employee is concerned about the maximum out-of-pocket expenses that could be incurred with the current design and decides to change back to the $3,000 annual deductible.

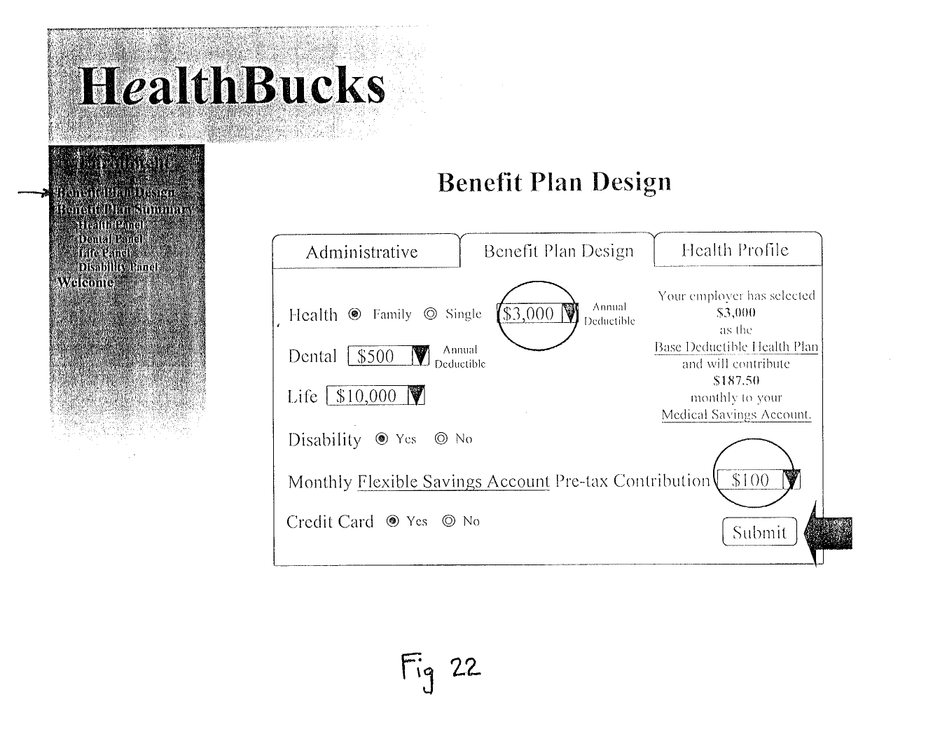

With reference to FIG. 22, the employee decides to not only change the annual health deductible but to increase the pre-tax contribution to the HealthBucks FSA option. This money will be used first in the smart card logic as it is “use-or-lose money” (if not spent during the calendar year, the employee forfeits the balance).

After making these changes, the employee submits the design for costing.

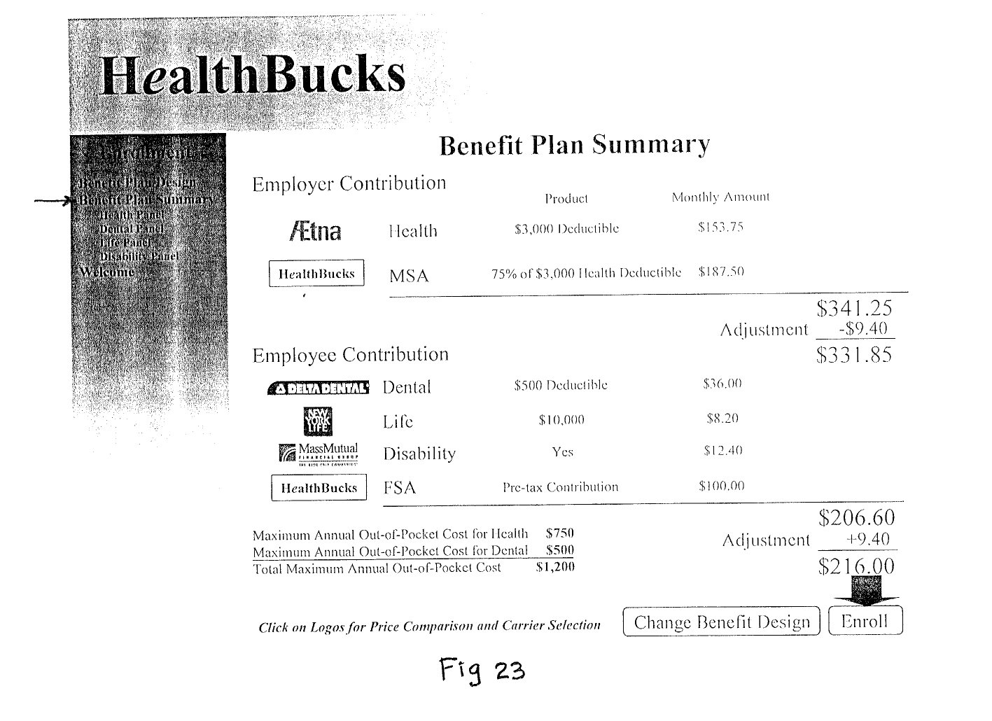

With reference to FIG. 23, the employee is satisfied with the tradeoffs that he/she has made and decides to submit the plan design to HealthBucks for enrollment and execution.

HealthBucks will execute all of the administration to establish the membership, set up billing procedures, notification of insurers, etc.

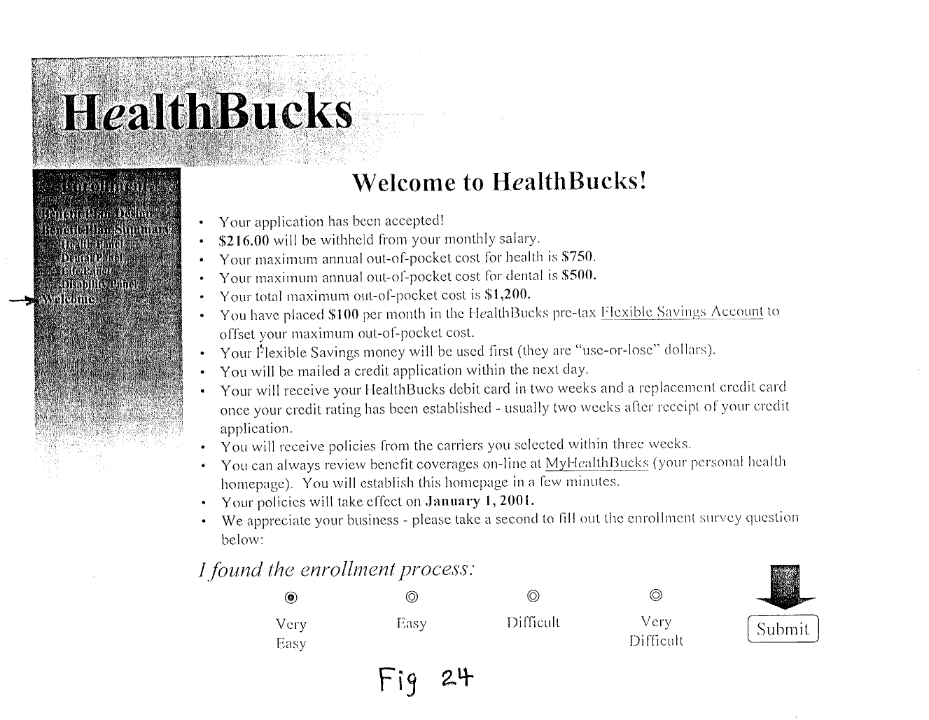

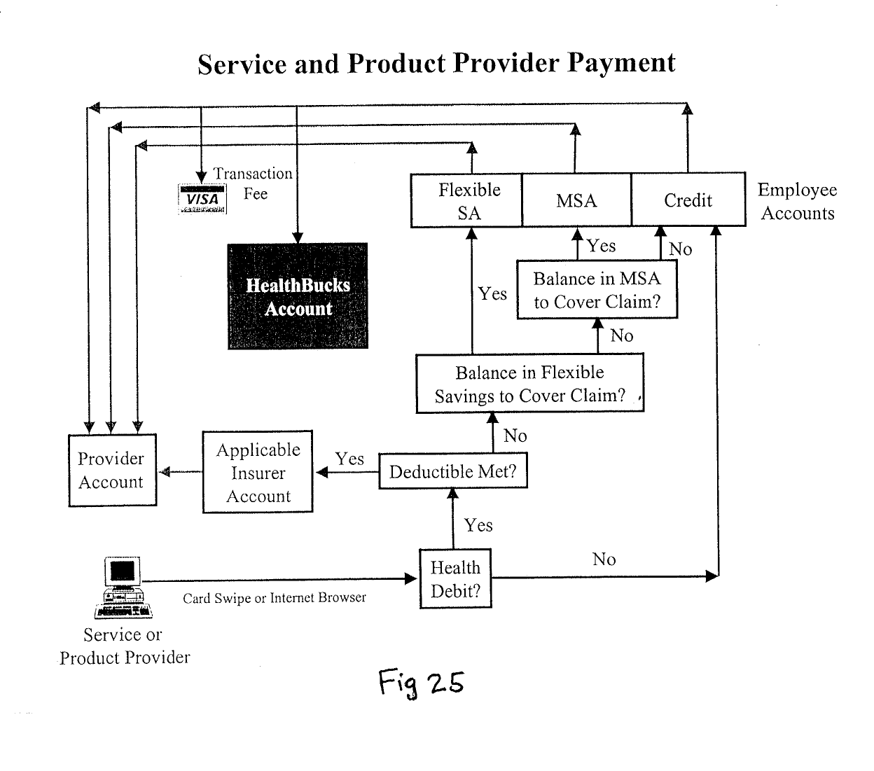

With reference to FIG. 24, HealthBucks welcomes the employee as a new customer and provides a summary of monthly contributions, out-of-pocket expenses, coverage effective date, and other information outlining future actions that HealthBucks will take to service the customer (e.g., cards, policies, and credit application).

The employee can review their benefit package and coverages online at MyHealthBucks whenever they desire.

HealthBucks is designed to provide multiple opportunities to collect information on its key processes such as employee enrollment.

Following submission of the survey question, the employee is provided the final segment of its enrollment process, the health profile. The health profile establishes the personalization criteria of the employee's personal health homepage—or MyHealthBucks. It is from this page that the employee will link to his/her HealthBucks account, benefit coverages, eCommerce opportunities, provider marketplace, etc.

The HealthBucks system maintains or has access to algorithms and data tables from different participating and possibly non-participating insurance programs. The screen of FIG. 11, lays out the premium, the total and the breakout for what the employer will contribute and what the employee contributes. Also, tabs or perhaps links may be provided; like the health part might be a link, and the user could click on health and it will drill down to another level to show the three insurance providers, and their respective premiums. The employee may elect to pay more for the same type of coverage based on provider preference.

Referring to FIG. 1, the Insurance Data tables and Algorithm Databases block holds insurance provider specific information and may be multiple choices fed through the application server and provided to the user.

Participating insurance providers may download the information to a database at the Home service or the information may be stored at a database at the insurance companies.

For instance, the insurer accesses to the home server such as by selecting a particular access point by selecting from “Are you an employee?,” “Are you an employer?,” etc. Upon selecting “an insurer,” a window pops up and requests a password. Upon successfully logging on to the site, the insurer will have access to their tables and be able to update and maintain the data therein.

The application server calculates all the premiums.

HealthBucks could outsource the application server or could employ a more complex home server having the insurance tables and algorithm databases under that roof. The home server connecting with participating insurance providers receives data for storing into the insurance data tables block. The insurers maintain their own algorithms.

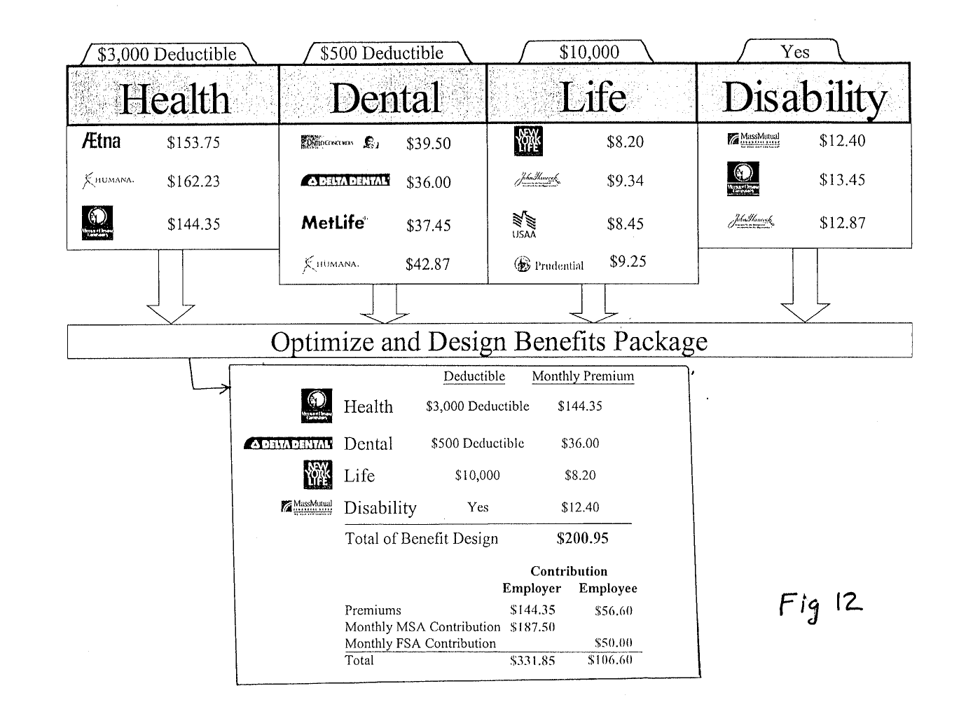

Referring now to FIG. 12, when an employee signs up for the plan they get a quote for health and it says $3000 deductible $144 per month. The employee has the ability to click on the word health and the system will present the insurers that competed for that $3000 deductible and their premiums. From that page an employee can click on the logo, and the system will link to a description of the company. It would give information on the company and also the insurance product itself. Also, the system may provide a link to the insurance provider's server.

In one embodiment, the system accesses servers and pulls data into tables and compares the insurers in terms of their plans. Insurers may want to do medical underwriting or if it is a large group, they may want the group to provide their last year or two worth of claims history and other data. However, with a high deductible product, insurers will typically provide that without requiring detailed medical history. The employee still may have to enroll and the insurance company will ask questions regarding the employee's health status and pre-existing conditions. With high deductible policies, the types of information needed lends itself to employees being able to provide that in real time via the Internet. And you can do that with a datatable data lookup. High deductible policies much more closely resemble life insurance, dental, and disability. All that is driven by how old you are, where you live and work, whether you have a family or not, whether or not you are a smoker, etc. It is a simpler type of insurance that lends itself to bundling and providing real time premiums over the Internet.

For instance, a consumer goes through, a questionnaire and at the end, the application server accesses the information in the data tables and so forth and generates the different costs associated with it and what the different insurance providers would charge for the high deductible policy. And then if the user wants to drill down and look at who provided health quotes; who provided dental and life and disability, they can drill down in terms of who competed for the quote and what were the quotes and get more information about the companies. HealthBucks provides ease of handling benefits by actually putting together products offered by a plurality of companies into a comprehensive benefits package. This is especially attractive to small employers. Larger groups can do this on their own because they have human resources departments that can get quotes from many different carriers and then package them all together themselves. But, a small company with no HR staff can use this system to build a plan. HealthBucks provides a human resource function for small companies.

Providing bundled packages simplifies it both for the employer and the employee. Typically an employee must complete multiple different forms and every form has a number of common data fields, e.g., first box—name; second box—address; third box—age, date of birth, social security number, etc. HealthBucks provides a centralized, common profile which is provided to all potential insurers for quotes, the employee fills it out one time and it goes to everybody.

One common form, certain fields may or may not go to all the participating providers. For instance, certain data would only relate to life, and certain to dental, health, and disability and so forth.

When people enroll they not only design their package and fill out all the administrative data, but centrally, or through leveraging content providers, they take a health risk appraisal and they get some feedback on that. For an employer, the system can aggregate the results of the health risk appraisals and give the employer feedback on the state of health of its employees. For instance, if HealthBucks determines based on internal data that 60% of the employer's workforce is overweight and 25% of the workforce are smokers, then it could directly or through content providers provide programs for employees to help them either quit smoking, provide them reduced price on fitness centers, etc.

In this way, HealthBucks provides valuable feedback in real-time enabling employers to prioritize needs so they do not put unnecessary programs in place. If, smoking is the biggest problem facing an employer's group of employees then it can implement an anti-smoking campaign. HealthBucks uses routines and tables to asses the health issues of an employer and may provide employers with adjustable threshold values at which action is suggested or prompted.

The health content provider can provide the health risk appraisal and can maintain such information in a personal profile database. HealthBucks, directly or via separate content provider, can personalize all the content delivered to users. For instance, on a health risk indicating that an employee is a smoker, when that person brings up that initial page, “myhealthbucks.com,” the content provider, will provide content about smoking and its adverse effects.

With reference to FIG. 12, a health portal enables the consumer and other stakeholders to navigate the system and build and access their personalized homepage (myhealthbucks) that links them to their insurance market place, to product and services market place, and to their own personalized information center and medical financial accounts.

If the user is a smoker and not interested in receiving information about stopping smoking, then HealthBucks can enable the user to disable this feature. This may be locked out by an employer.

Consumers that make return trips to the home server will access the standard healthbucks page, with a link to “myhealthbucks.” And when they go to “myhealthbucks,” that page will reflect the missing profile. HealthBucks can offer news and sports. The health content will be what the health care provider server is set up to deliver to them. If they are a smoker and they are overweight then they will get lots of content about stopping smoking and about health studies that are done about being overweight. And also from that personalized home page there will be a link to “myhealthbucks account” that will, take them out to a bank account on a different server. Healthbucks.com is a launching pad to all of the products and services that HealthBucks offers.

Provider's personalized page—If the user is a provider . . . let's say a doctor, then the “myhealthbucks” page might reflect what the user is currently marketing in HealthBucks in terms of discounts. Or it could also have “myhealthbucks account” where a doctor can use HealthBucks; (1) to set up his business financial system; (2) to buy his malpractice insurance online; (3) to get health care information—(if he signs up as a dermatologist we push him information on dermatology articles); and (4) in the provider and product services market place, to get educated online to keep his credentials up (CME credits).

HealthBucks can provide access to commerce partners, e.g., we can offer them education., we can offer them books, they could link to Amazon.com and buy books, they could link to a company called Medibuy which sells books and medical supplies, etc. The system can link doctors to sites, where they can go out and auction and purchase medical supplies. You can take this model for the consumer and you can also apply it to a doctor.

And it starts at the health portal, are you an insurer, a consumer or are you a doctor. If you are a doctor you are directed down a different path, but the model is still intact. You could use the HealthBucks card to run your business. All patient payments are financial transactions, they are just going from their HealthBucks account into a provider's account.

Money spent online for books and medical supplies is just taken out of the provider's HealthBucks account. The card set up for the doctor is probably not going to have the medical savings account. It could, but it could also have a business account. and it could have a credit account.

Also, doctors can offer HealthBucks to their own employees and even give their employees further discounts. In other words, they give discounts to HealthBucks members and then they give even deeper discounts to HealthBucks members who happen to be employees of theirs.

The doctors, individuals, partnerships, etc., represent a segment of the small business market and provide a great opportunity for grass roots marketing. As a member goes to a participating physician and they're complaining about their insurance the doctor can refer the patient to HealthBucks.

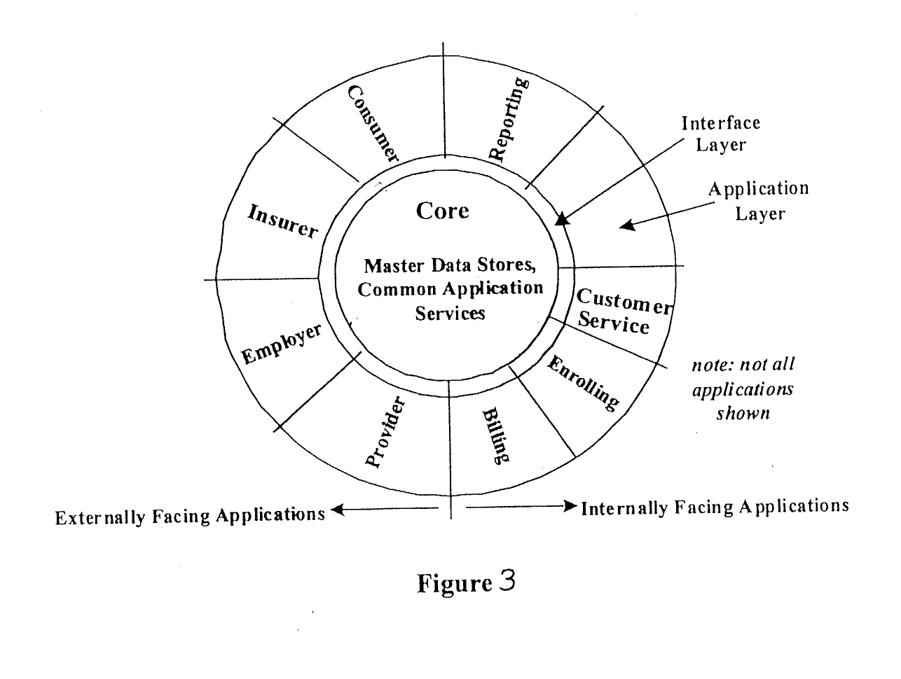

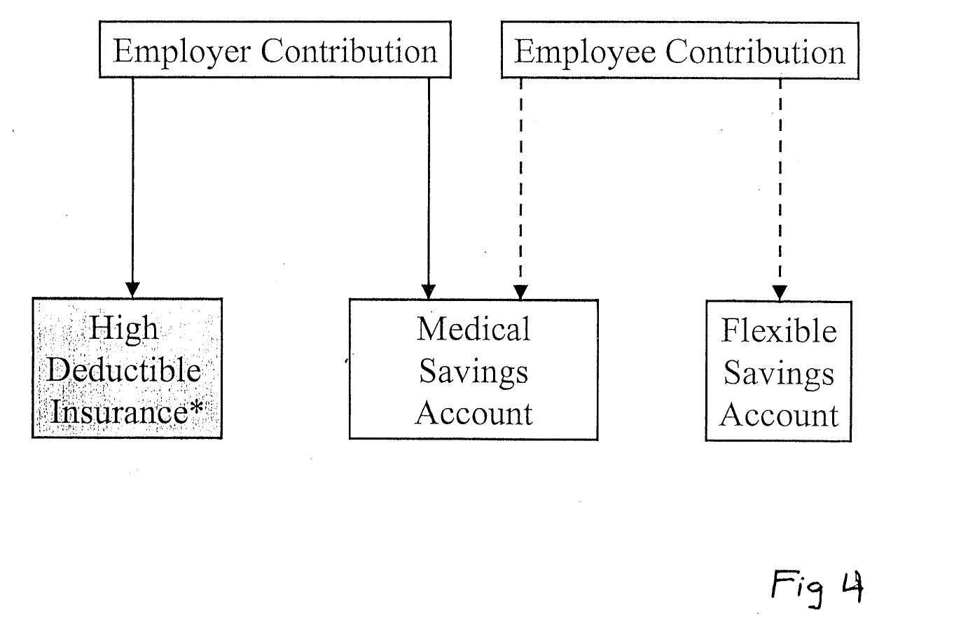

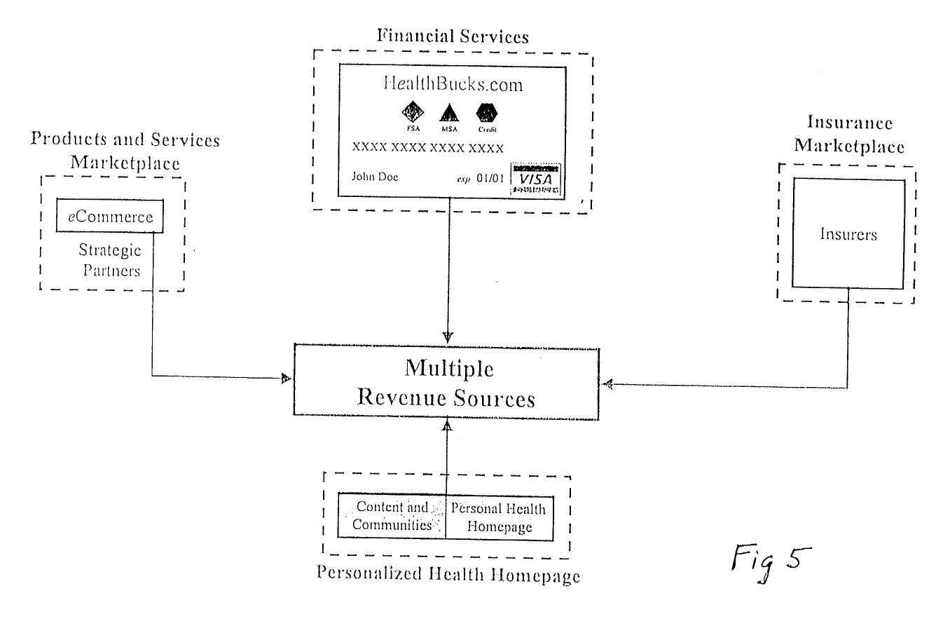

With reference to FIGS. 1 and 3, a diagram shows the architecture conceptually in terms of having a digital core. And the applications, there are externally facing applications for your commerce partners, for consumers, for the insurer, for employers, and for providers. These applications interact with the overall system. For instance, the applications will enable consumers to design their own package and to develop their own personalized health information homepage. An application for providers to market themselves. Seventy percent of practices have less than five or six doctors in them. HealthBucks enables these smaller practices to distinguish themselves out in the market place and build a community or a place where a physician or a doctors group can go online. A template where they can put in their name, their address, who the doctors are, what their credentials are, etc. is provided. And they could put a picture of their practice, directions how to get to it, and then a description of what their philosophy is in their office. And they could put that out online under a zip code. And then a consumer, let's say they're looking for a discount, they go there to the market place into the provider database and there's a search engine on there. They put a zip code in and then this practice, along with say three or four other practices, are presented as discount providers and then the consumer can see what their philosophies are and see where they're located in terms of how far they are away from their home or their workplace. That's a way of bringing consumers and providers together as well.

The internal and external stakeholders illustrated in Tables 1 and 2 show those that interface with HealthBucks. Some of them are outside the company and sell products and services or want to buy something or they provide the insurance products or they want to join the discounted network. And then the internal stakeholders are all the internal people within HealthBucks that have a variety of functions.

Also, physicians tying into this, can maintain their schedules and appointments and patients may have access to certain data and doctors can connect up and send out messages to their patients. For example, notifying them of their appointment, like a reminder, via e-mail. The patient gives them their e-mail, mobile phone, or etc., and they can generate and forward/receive messages.

A consumer could go out online or they could access it from their appliance, e.g., mobile phone, and they could get a warning that the doctor is two hours behind schedule, come in two hours later.

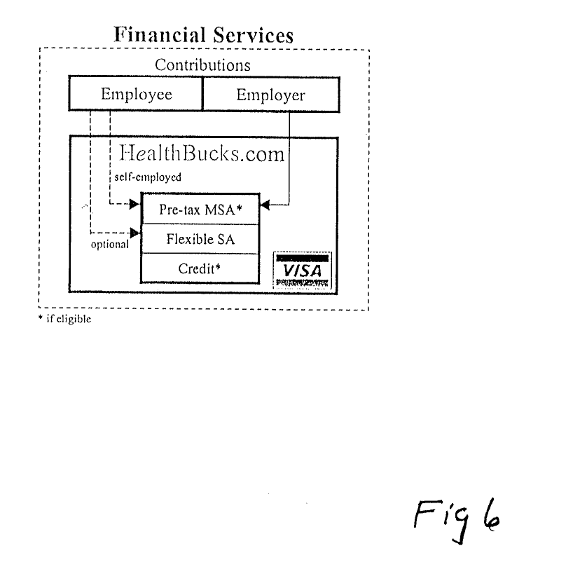

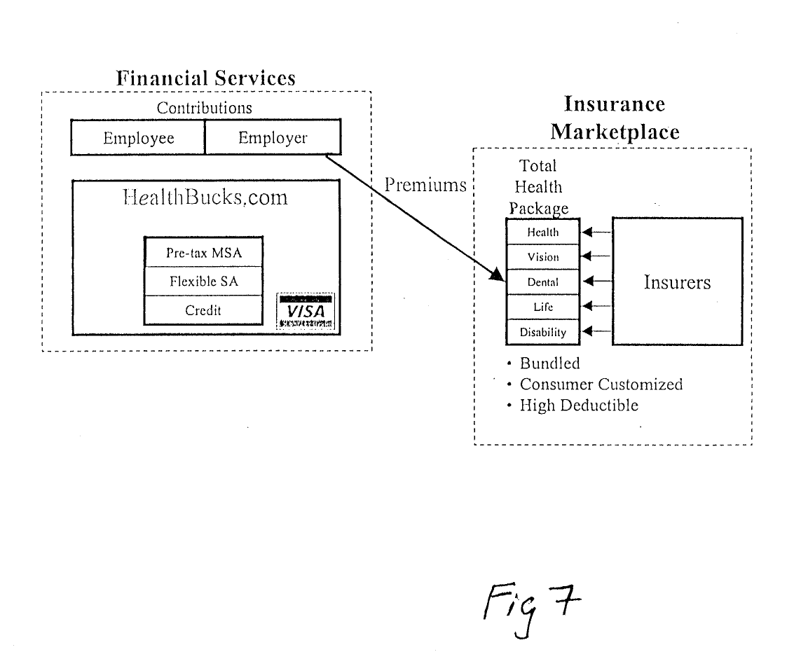

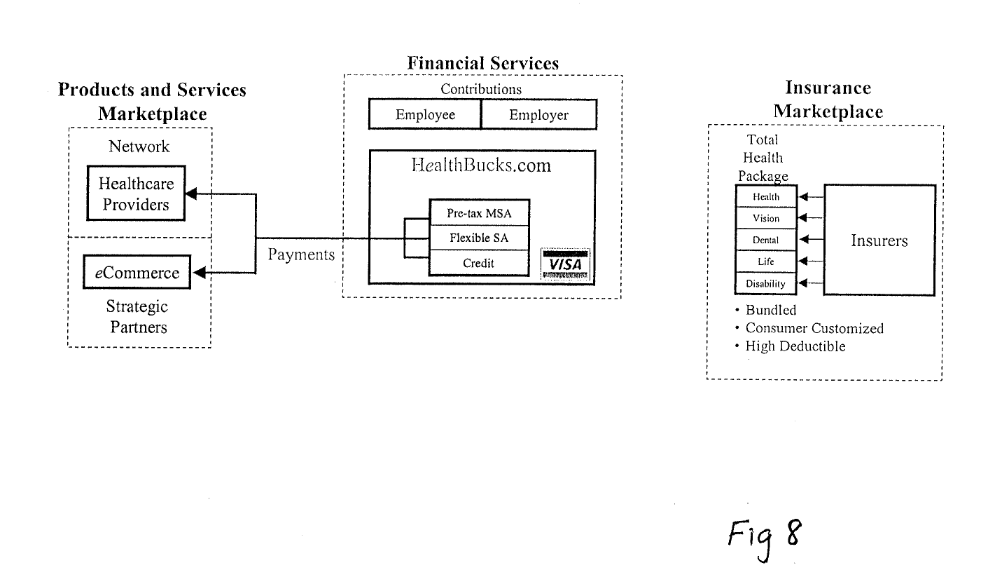

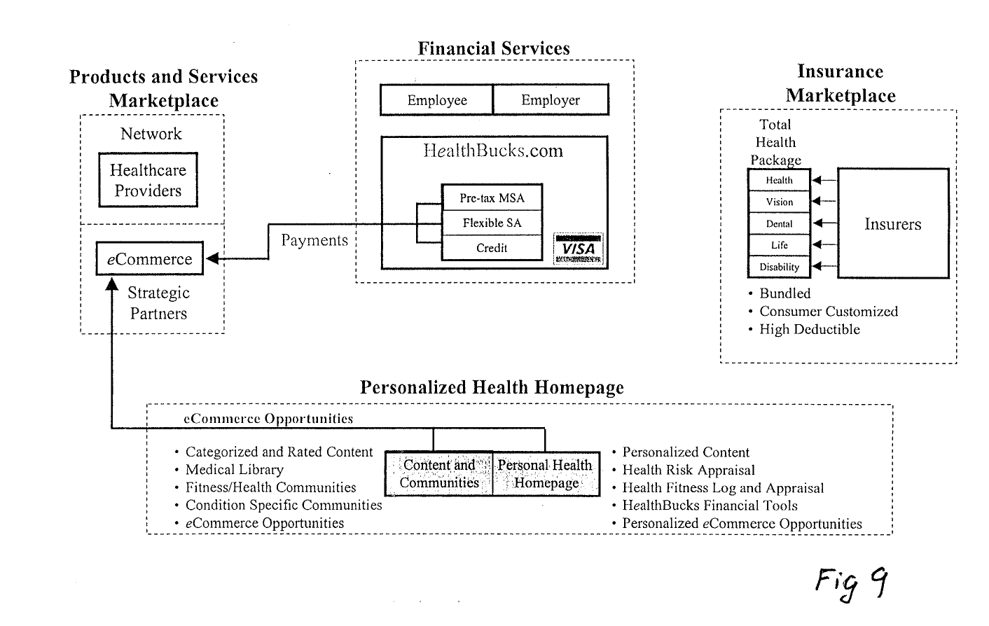

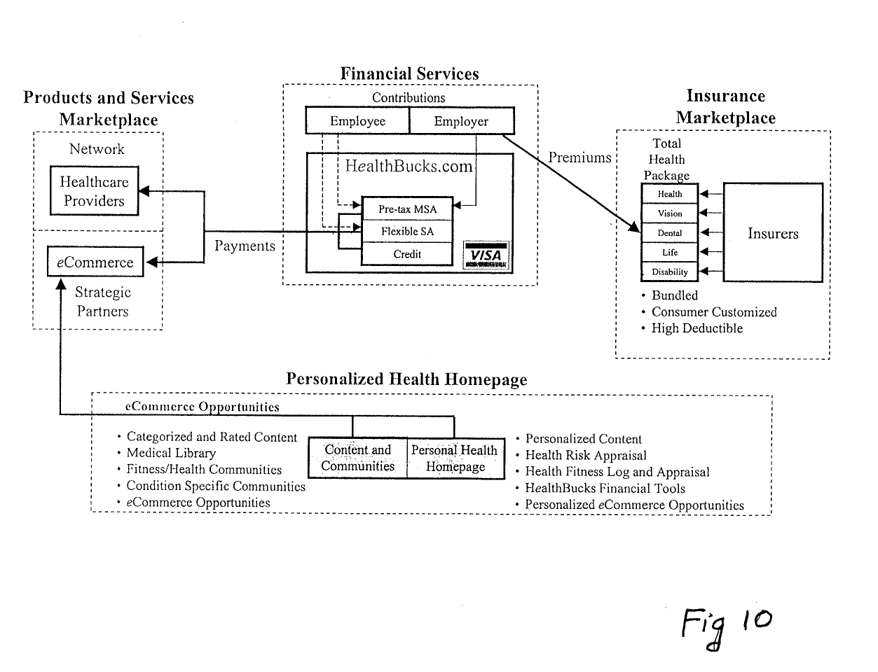

With reference to FIGS. 5-10, financial side, banking transactions, if a user clicks on “myhealthbucks” account the system connects up with another, application server that retrieves information from different sources. It processes calculations and provides results to the users via their online account. Preferably the transaction data is not internal to the home server architecture. The account information itself will be maintained by the institution handling their transaction.

Referring now to the HealthBucks Card Transaction of FIG. 1, let's say someone has used their Health Bucks card either online or in a physical location and the card has been swiped and that financial transaction is going through the banking system. In other words, it's not going directly through the Health Bucks system and it's not going through an insurer. Doctors only file about 30 percent of claims electronically. The rest are done by paper. The majority of the claims in health care come from doctors, and not the hospitals. The majority of claims that are filed and processed are analog.

On the transaction side, when a user goes to a doctor, swipes his HealthBucks card and pays directly, with the HealthBucks card, an automatic data update can occur. HealthBucks, and the user, can keep a running chronology of treatment, health maintenance, and spending. This data can be provided to a content partner to update the user's medical record. Consumers can then track down this information.

Also, the records could be updated automatically with the card swipe where codes are set up and applied to identify qualified health-related expenditures and to debit the user's MSA account and so forth. The codes can be detailed enough to actually build a record of the type of expenditures and reflect what kind of treatment the patient/user received.

To address privacy concerns, the codes can be encrypted. For instance, a user goes to his doctor who has a list of codes. When the card is swiped, the swipe is associated with a particular code that's encrypted in the transaction data. And then back at the home server the information from the banking transaction system is decrypted and information retrieved.

HealthBucks offers a great opportunity in terms of using the financial transaction system, in other words, every time a transaction is made that's health-related, there's an opportunity to code the data.

Another feature is an online tool for analyzing the data, for example, at the end of the year a user, employer, provider, etc. can for instance, make a pie chart illustrating health expenditures, etc. This much for pharmacy, this much for office visits, this much for lab, whatever, aggregate all that data as HealthBucks. HealthBucks could aggregate that data and provide it back to employers, this is where the health dollar is going, etc. It also would be valuable information for insurers to have and, it could be used to substantiate the medical savings associated with HealthBucks.

The whole financial transaction would be done within the banking system and maintained by the bank. Each bank statement to members would have the HealthBucks logo by each health related entry. When the customer is on the home server and they go to “myhealthbucks” and then from “myhealthbucks” they go to “myhealthbucks” account and they click on that, an applications server links to a server or to a mainframe that the banking system has and draws account information from the banking system as well as from the member account database in terms of deductibles. HealthBucks can provide on myHealthBucks account not only what the transactions were, but also show how much money the user has spent toward this deductible.

With respect to a Member Account Database, that information is internal to the HealthBucks home server and is updated by the banking transaction system. The member account database includes the member list and profiles all the products they've bought and what all their deductibles are, etc.

The most complex things about indemnity insurance or high deductible insurance is that people do not want to be burdened with managing piece of paper by piece of paper by piece of paper, where they are toward their deductible. HealthBucks tracks and maintains this information for the user.

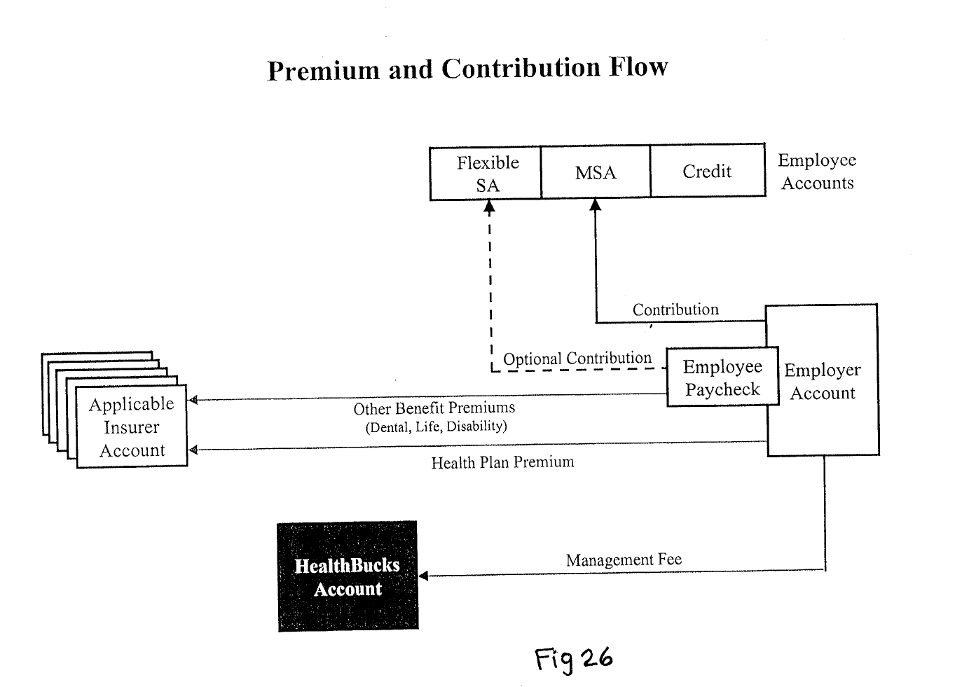

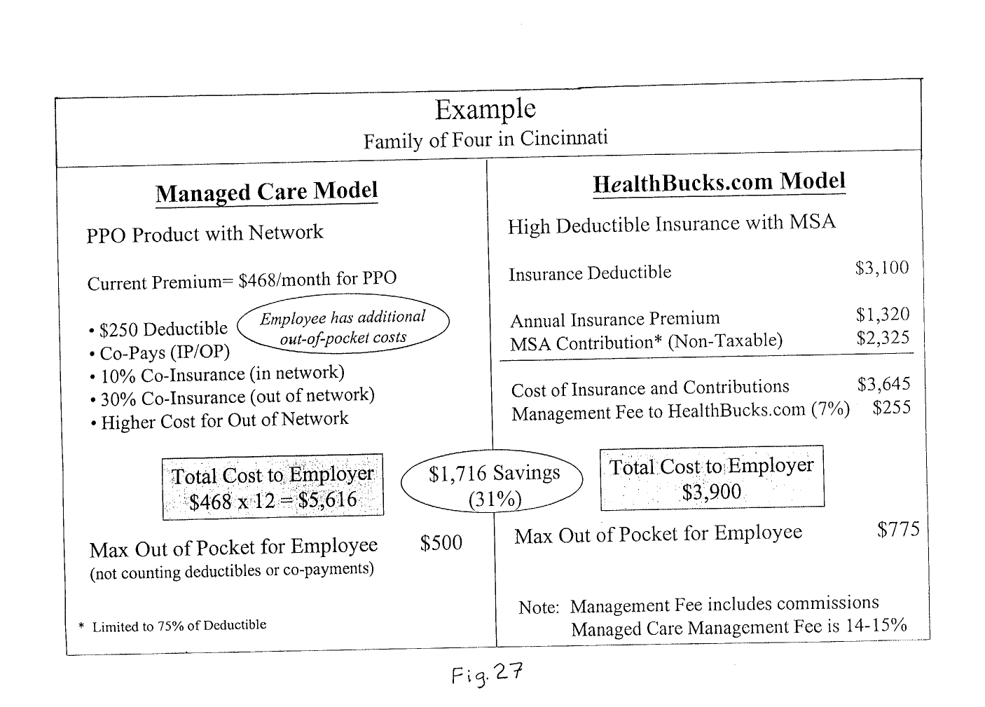

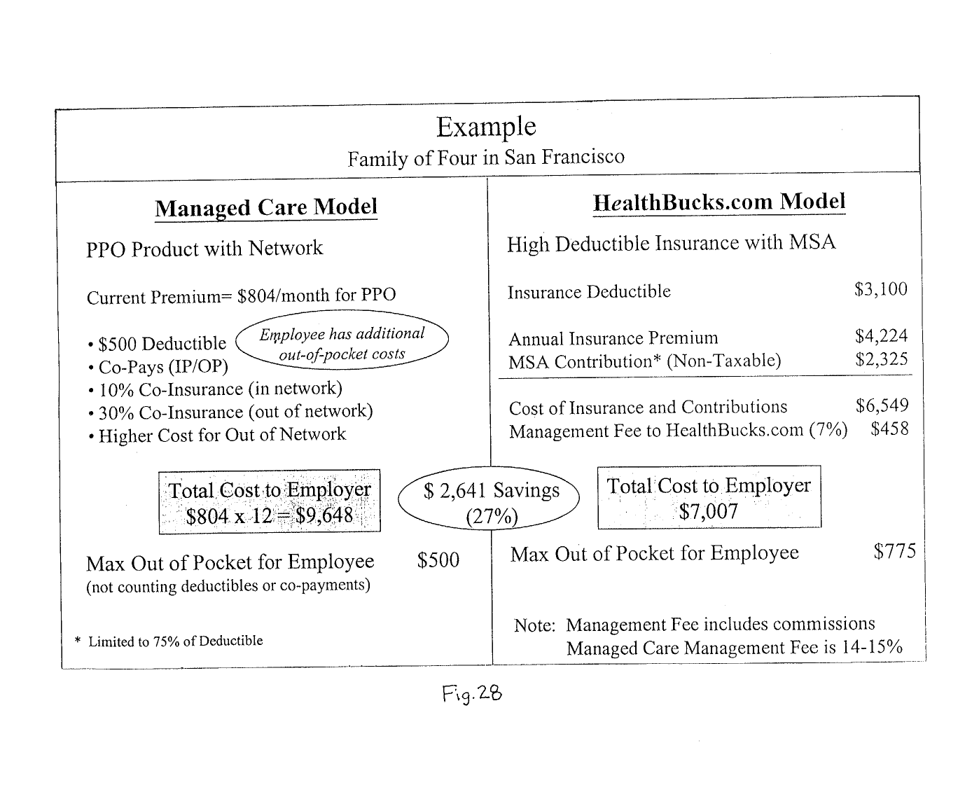

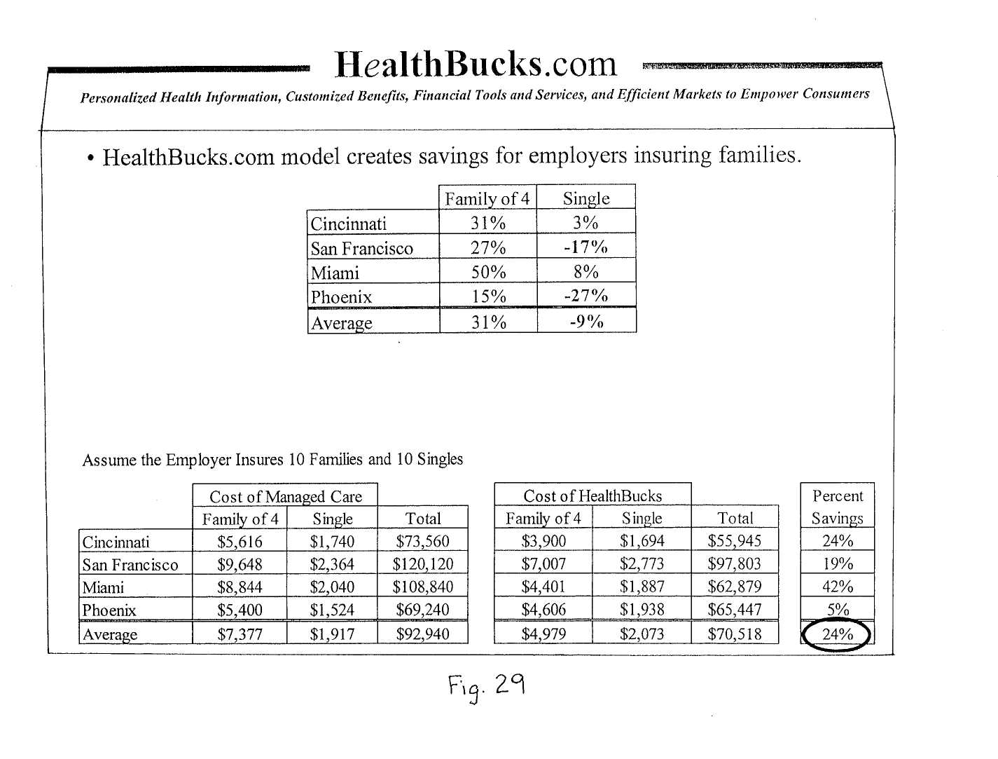

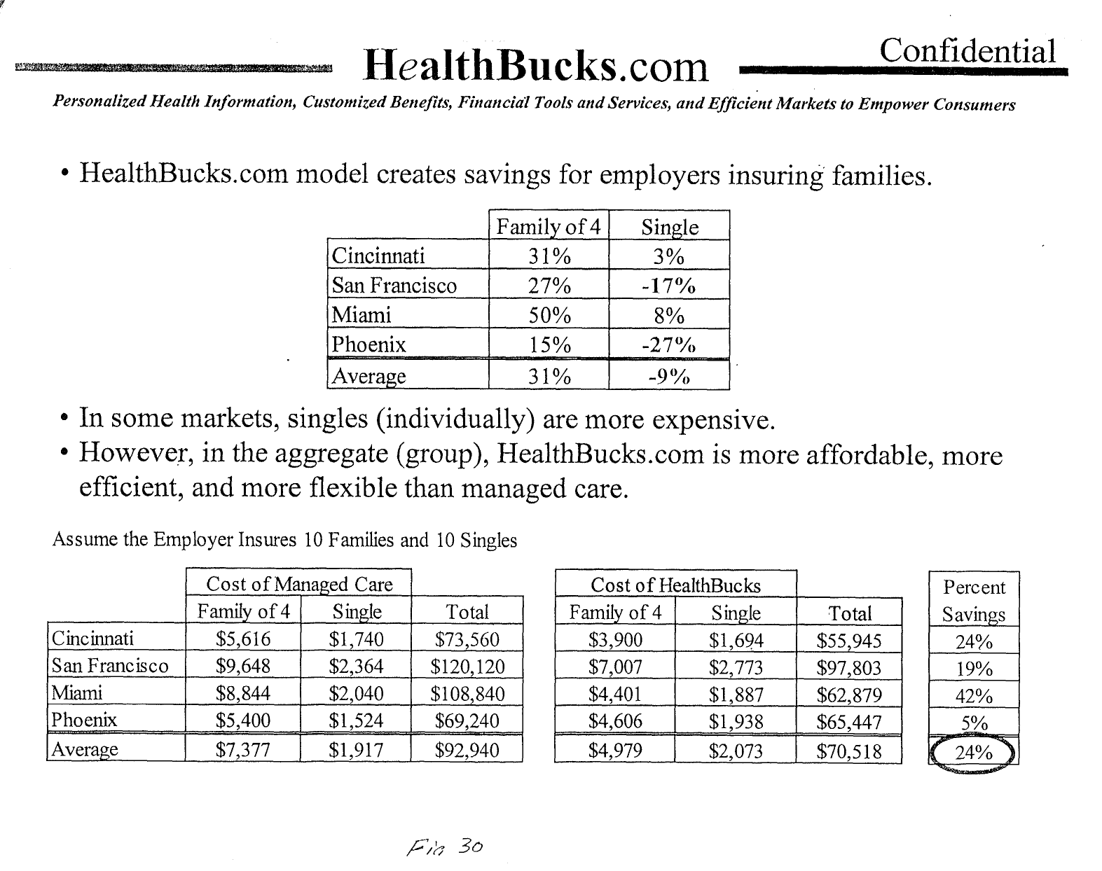

With reference to FIG. 26, Service and Product Provider Payment, lets say a consumer has set up a flexible savings account, which is pretax, but only the user can contribute to it and it's use or lose. In the HealthBucks system, the maximum out of pocket cost for a consumer is going to be 25 percent of their deductible because their employer will cover 75 percent. And so the user is still going to be out, on a $3,000 deductible, the first $750, whether it's out of the flexible savings account (FSA) or the medical savings account. At some point in time, the user runs their MSA down to zero, they are going to have to cover the next 25 percent of the deductible. The FSA allows the user to put pre-tax money into their flexible savings account and use it first and let their medical savings account continue to grow and grow and grow year over year.

From the consumer side, a transaction that is not a health debit goes on the user's credit card, if they have credit on their card. And if they do not have credit on the card, the processing entity will decline, in forming the merchant.

If it is a health debit, the first step examines whether the user has met their deductible. There could be additional steps, e.g., the first thing we might want to ask since this is a mobile account, maybe you've moved on to another employer who doesn't offer HealthBucks but you still have money in your MSA. The first thing we might ask before we ask deductible met, we might ask do you have high deductible insurance with Health Bucks. And if it's yes, then you go to the deductible. If you don't, then you go straight to one of the accounts if there's any money left in those. But if you do have a current HealthBucks insurance policy and you have met your deductible, then the system sends the bill to the insurer.

HealthBucks verifies that members have met their deductible by sending a transaction to the insurer showing a history of the year to date transactions that have been made. The consumer does not have to mail in receipts to verify to their high deductible insurer that they've met the deductible. If you've met your deductible or if you have not met your deductible, then we want to know do you have any money left in either your flexible or medical savings accounts. Money is taken out of the flexible account first, and second, then the logic is go to the MSA, and if we're out of money there, we go to the credit.

HealthBucks maintains the transaction history and is able to record deductibles. Also, on that chart, at “deductible met,” there could be a box in there to “update deductible status,” the consumer can use a tool to show the progressing toward this deductible. HealthBucks directly or via the banking transaction processes this data. Technology such as smart card technology can be employed. The logic could be at the very front of the Health Bucks account that puts that deductible piece in there or with the bank. The user would be issued a HealthBucks card or banks could associate an existing charge card with a HealthBucks account. When the information is received, the bank installs that logic for that particular account. In this embodiment, HealthBucks leverage the exists financial system and all those processes.

The dental process would act just like the health model here as well as disability and life. HealthBucks provides bundling. FIG. 12 illustrates the bundling process—each one of those products is discrete. Health Bucks goes out to insurers along all those lines, offers products to HealthBucks customers, and one of the significant concerns is coverage. HealthBucks creates a marketplace for insurers.

Based upon what the consumer has elected in terms of deductibles, HealthBucks will bring up all the insurers that can give that user a quote and what those quotes are, and then it shows how that funnels down ultimately to a users package. HealthBucks presents to the consumer during this selection or bundling process the different options of the different providers that are available and the costs associated with each one.

If the consumer wants to drill down further, they can access information about each one of the companies. Links to the provider site or other sites may be provided to enable the user to find out more about the particular products. To differentiate between, let's say, three dental providers and three health providers and three life providers.

With reference to FIGS. 11 and 13, say a user builds up their MSA account and they want to take their deductible up above, $3,000 to lessen the cost of the insurance.

So in other words, if a family, the user can go from $3,000 to $4,500 deductible.

Now, if the user is self-employed, this is wide open. If self-employed, go up to a $4,500 deductible and put three-quarters of that in the MSA, tax-deferred. There will be more out-of-pocket costs, because now the out-of-pocket cost is going to be 25 percent of $4,500 rather than $3,000.

The self-employed have a lot more choices in this than do the employed. What works best for an employer is the low end deductible. It's cheaper for the employer. So the employer may allow you to take a higher deductible but it's only going to pay three-quarters of that $3,000 in your MSA, so the user will have more out-of-pocket expense if a catastrophic event happens. HealthBucks provides you the tool that will bring the bundle back to the user showing worst case out-of-pocket cost. And then the consumer decides if that's what they want.

HealthBucks Architecture can be based on either NT or Sun/Oracle platform. Insurance Quote process example, you're putting in your age, whether you smoke or not, how old you are, whether you're a family, where you live, those are basic things that you put in for all these different insurances. And then the system will via multiple application servers or multiple servers that are working in tandem, one in health, one in dental, one in life and disability, but they are going to come back as a package. The consumer puts in the base data needed to bring the bundle back. The application server hosts the application that does all the calculation and configures a report to the user. Tere are additional servers with data bases that pull the data in and make the calculations.

Again referring to FIG. 1 and, the “Commerce Partner Database” on HealthBucks.com or MyHealthBucks, there's a link, e.g., Shopping Mall, and a server where you put together a data base of all your commerce partners and what they've got on special and you might give them access to their part of the mall where they can continue to update it. Or it might just go to their server. in other words, you might go to the home server. A user accessing the shopping mall clicks on that button and that takes you to the HealthBucks server and database. The user is presented with pharmaceuticals, vacations, fitness centers, etc. And then once you click on that, you actually go to their website. HealthBucks tracks such activity and generates clock-through activity reports. The health care space could be divided up in terms of health products and fitness products and vacations, travel, books, information, education, etc.

Now with reference to the Provider Network Database as well as the Marketing Database of FIG. 1, HealthBucks provides consumers with price protection, to avoid paying exorbitant fees. HealthBucks can provide a discounted network and get doctors to compete for price or it can, “rent” an existing discount network, e.g., Beach Street, Multiplan, and any number of others. Basically these are doctors' networks wherein the doctors are already under a contract and a fee schedule.

Also, research shows that doctors will take anywhere between five and ten percent less if you pay at the point of service. HealthBucks provides an opportunity for providers to market their own discounted services to HealthBucks members.

HealthBucks Information and Operations Database of FIG. 1, internal browser applications that take the internal business processes, the data of the business, etc. and allows employees to access the HealthBucks databases and applications. The information database is more externally oriented, toward the external stakeholders, but the operations database e-enables all of the internal processes that are going on in the HealthBucks system and allows the employees of the company to better do their jobs because they have up-to-date data and information.

Insurance provider stakeholders design benefits plans and make tradeoffs, and are external stakeholders. A consumer uses a browser-based appliance, goes to HealthBucks home server, goes to myHealthBucks and is able to sign up and, given what their employer contribution is, they're able to go through an application server and put their inputs in terms of the type of bundled benefit package they want and then get the feedback from it. And then from there they can continue to design it and make the tradeoffs and see not only the change in their benefits but also in terms of the costs, first of all, what the employee pays and then what they have to pay. That's how that applies to the cloud diagram. A consumer wants to enroll in a design plan. Well, once they design the plan, they want to enroll in it. And so when they enroll, they become a data entry into a member account database. And then we create a bank account for them. If they've indicated that they want credit, the bank will mail them a credit card application. Once they enroll, HealthBucks notifies the insurers and data is transmitted throughout the system. Data is transmitted to the member data account, member account database. The system set ups the bank account and notifies the insurers with the administrative data—these are the people that have enrolled and what policy they want. And then, the insurers at that point will mail the user/member their policy.

Although particular embodiments are described hereinabove, other modifications to the embodiments described above can be made without departing from the spirit and scope of the invention, as is intended to be encompassed by the following claims and their legal equivalents.

TABLE 1

| | Internally Facing | | | | | |
|---|---|---|---|---|---|---|
| | | | Business | | | |
| Stakeholders and Requirements | Sales | Marketing | Development | Finance | Customer service | Business Management |
| Sales | | | | | | |
| HealthBucks wants to allow consumers to design their benefits | X | | | | | |
| package and make tradeoffs | | | | | | |
| HealthBucks wants to provide benefit | X | | | | | |
| coverage information on-line | | | | | | |
| HealthBucks wants to allow insurers the | X | | | | | |
| flexibility to change pricing in real time. | | | | | | |
| HealthBucks wants consmers to enroll on-line | X | | | | | |
| HealthBucks wants to track sales by region, | X | | | | | |
| market and salesman | | | | | | |
| HealthBucks wants to forecast sales | X | | | | | |
| HealthBucks wants to measure results of market campaigns | X | | | | | |
| Marketing | | | | | | |
| HealthBucks wants to market its products to employers | | X | | | | |
| HealthBucks wants to track site traffic for | | X | | | | |
| consumer behavior patterns | | | | | | |
| HealthBucks wants to datamine its customers | | X | | | | |
| purchasing behavior | | | | | | |
| Business Development (Insurance Marketplace) | | | | | | |
| HealthBucks wants to create a marketplace of insurance products | | | X | | | |
| HealthBucks wants to develop and manage its | | | X | | | |
| Insurance Marketplace for coverage | | | | | | |
| HealthBucks wants to provide feedback to insurers | | | X | | | |
| on sales accomplishments | | | | | | |
| Business Development (Product and Services Marketplace) | | | | | | |
| HealthBucks wants to create a commerce marketplace | | | X | | | |
| HealthBucks wants to create a dynamic network | | | X | | | |
| of discounted providers | | | | | | |
| HealthBucks wants to add and drop commerce partners | | | X | | | |
| HealthBucks wants to track performance of commerce partners | | | X | | | |
| HealthBucks wants to create a community for providers | | | X | | | |
| to market themselves to its members | | | | | | |
| Financial | | | | | | |
| HealthBucks wants to track all financial transactions | | | | X | | |
| by type and amount | | | | | | |
| HealthBucks wants to maintain breakout of account status | | | | X | | |
| HealthBucks wants to bill customers (receivables) | | | | X | | |
| HealthBucks wants to pay for services (payables) | | | | X | | |
| HealthBucks wants to perform financial analysis | | | | X | | |
| Customer Service | | | | | | |
| HealthBucks wants to answer questions via e-mail. | | | | | X | |
| HealthBucks wants to answer questions voice over IP | | | | | X | |
| HealthBucks wants to answer questions over the phone | | | | | X | |
| Business Mangement | | | | | | |
| HealthBucks wants to near real-time operations | | | | | | X |
| summary of its entire business | | | | | | |

TABLE 2

| | Externally Facing | | | | |
|---|---|---|---|---|---|
| | | | Products and Service | Insurance | Customer |
| Stakeholders and Requirements | Content | Banking | Marketplace | Marketplace | Service |
| Consumer | | | | | |
| Consumer wants to design benefits plan and make tradeoffs | | | | X | |
| Consumer wants to enroll in designed plan | | | | X | |
| Consumer wants to contribute to pre-tax FSA | | X | | | |
| Consumer wants to pay for benefits that employer doesn't cover | | X | | | |
| Consumer wants to check coverages of selected benefits | | | | X | |
| Customer wants to view their account and track transactions | | X | | | |
| Consumer wants to pay for on-line and off-line products and services | | X | | | |
| Consumer wants to locate discount services from providers of commerce partners | | | X | | |
| Consumer wants to manage his/her/family's health account | | X | | | |
| Consumer wants to receive and search for personalized health information | X | | | | |
| Consumer wants health tools to assist in managing family's health | X | | | | |
| Consumer wants to track health/fitness progress (weight, BP, journal, etc). | X | | | | |
| Consumer wants to shop on-line for health, fitness, and recreational products | | | X | | |
| Consumer wants to ask a question on benefits, accounts, and services | | | | | X |
| Consumer wants a line of credit | | X | | | |
| Employer | | | | | |
| Employer wants to provide the HealthBucks bundled benefits product to | X | X | X | X | X |
| his/her employees | | | | | |
| Employer wants to define contribution of benefits | | X | X | | |
| Employer wants to pay for benefits | | X | | | |
| Employer wants feedback on employee expenditures | | X | | | |
| Employer wants aggregate information on the health state of employees | X | | | | |
| Employer wants to ask questions on products, account, and services | | | | | X |
| Provider (Physicians, Hospitals, etc) | | | | | |
| Provider wants to market and change their discounted services to consumers | | | X | | |
| Provider wants to receive timely payment for services rendered | | X | | | |
| Provider wants to check status of payments and account balances | | X | | | |
| Provider wants to locate discounted services for their practice/business | | | X | | |
| Provider wants to shop on-line for supplies and discounted services | | | X | | |
| Provider wants to pay for products and services bought on-line | | X | | | |
| Provider wants to advertise and sponsor content and services on-line | X | | X | | |
| Provider wants a line of credit | | X | | | |
| Provider wants to consolidate business expenses | | X | | | |
| Insurer | | | | | |
| Insurer wants to distribute their products to consumers on-line (new channel) | | | | X | |
| Insurer wants to maintain and change its algorithms and data tables in real-time | | | | X | |
| Insurer wants to check deductible status of its members | | X | | | |
| Insurer wants to pay providers for amounts that exceed deductibles | | X | | | |
| Insurer wants to advertise and sponsor content on-line | X | | | X | |
| Commerce Partner | | | | | |
| Partner wants to offer e-commerce opportunities | X | X | X | X | |
| Partner wants to advertise and sponsor content on-line | X | X | X | X | |

I claim:

1. An online method for presenting one or more health related goods or services offered by one or more offerors to a user for viewing and selecting at a remote terminal, the method comprising the steps of:
a) storing in a storage device at a central location health product related information pertaining to one or more health related goods or services;
b) establishing an electrical communication between the central location and the remote terminal;
c) determining at the central location if the user of the remote terminal is a registered user, and if the user is not registered presenting the unregistered user with a user profile inquiry, whereby an unregistered user uploads to the central location user profile data and satisfies other registration requirements, the user profile being received and stored at the central location;
d) presenting to and viewing by the registered user at the remote terminal information, based at least in part on the user profile, pertaining to health related goods or services;
e) the user remotely selecting a particular health related good or service;
f) the central location presenting the user with cost information related to the selected health related good or service; and
g) the user repeating the viewing and selecting steps to build a health benefits package based upon options available to the user.

2. The method of claim 1, wherein at least one of the health related goods and services available to the user represents a health insurance product made available by an employer to its employees, the user being one of the employees.

3. The method of claim 1, wherein at least one of the health related goods and services available to the user is a generally available good or service made available based on qualifying data.

4. The method of claim 1, wherein the user profile inquiry comprises one or more of user name, employer information, user health history data, family member information, family health information and email address.

5. The method of claim 1, wherein at least one of the health related goods and services available to the user represents at least one of dental insurance, life insurance and disability insurance products.

6. The method of claim 5, wherein the health benefits package involves at least one of a flexible savings account and a medical savings account.

7. In an online system operated over a distributed computer network, the network comprising at least one server at a central location accessible to remote users over the network via remote terminals, and a storage device in communication with the server, a method comprising the steps of:
a) receiving and storing at the central location electronic information concerning at least one health related good or service from at least one offeror to be made available to remote users;
b) establishing an electrical communication between the central location and a remote terminal over the network;
c) determining at the central location if the user of the remote terminal is a registered user, and if the user is not registered presenting the unregistered user with a user profile inquiry, whereby an unregistered user uploads to the central location user profile data and satisfies other registration requirements, the user profile being received and stored at the central location;
d) presenting, based at least in part on the user profile, information related to one or more of the at least one health related good or service;
e) selecting by the user at the remote terminal at least one presented health related good or service and transmitting a request to the central location to receive additional information related to the selected health related good or service;
f) the user repeating the viewing and selecting steps to build a health benefits package based upon options made available to the user; and
g) storing at the central location information about the user health benefits package.

8. The method of claim 7, wherein the options made available to the user are comprised of insurance products made available to the user by the user's employer.

9. The method of claim 8, wherein the options are one or more of the group consisting of health, dental, life and disability insurance products.

10. The method of claim 7, wherein the user profile inquiry comprises one or more of user name, family member information, employer information, user health history information, family health history information, and email address.

11. The method of claim 7, wherein the user is presented with information related to deductable and cost for one or more health related good or service.

12. The method of claim 7 further comprising the steps of: selecting by the user at least two competing health related goods or services; comparing at the central location the at least two competing health related goods or services; and presenting to the user information pertaining to the comparative results.

13. An online system for presenting health related goods or services over a distributed network, the health related goods or services being presented over the distributed network to remote users, the system comprising:
a central location comprising at least one server and having at least one processor and at least one database, the at least one database for storing data related to the health related goods or services and user profile information, the central location server having a communication device for establishing electrical communications with remote users over the distributed network;
a remote terminal operated by a remote user and having a display and a data entry device, the remote terminal further having a communication device for establishing communication with the central location over the distributed network, the user having profile data stored at the central location; and
the central location further comprising a package module adapted to generate a user package comprising cost and deductable data associated with at least one health related good or service based at least in part on the remote user's profile data, the central location presenting the package to the user;
wherein the remote terminal displays the package information received from the central location to the user, the user communicating selection input via the data entry device in response to the displayed package information.

14. The system of claim 13, wherein the package includes at least one of health insurance, dental insurance, life insurance and disability insurance products.

15. The system of claim 14, wherein the package made available to the user is at least in part subject to the user's employer benefits offerings.

16. The system of claim 13, wherein the central location further comprises a comparing module adapted to compare at least two competing health related goods or services and to generate comparative results, the central location transmitting the comparative results to the remote terminal for viewing by the user.

17. The system of claim 16, wherein the user selects a desired health related good or service upon viewing the comparative results.
